(19) United States
(12) Patent Application Publication
(10) Pub. No.: US 2010/0023352 A1
(43) Pub. Date: Jan. 28, 2010

(54) System and Method for Improved Information Sharing by Repair Facilities for Managing Rental Vehicle Reservations

(75) Inventors: David G. Smith, Wildwood, MO (US); Owen R. Miller, Wildwood, MO (US); Trent Tinsley, Eureka, MO (US)

Correspondence Address: THOMPSON COBURN LLP, ONE US BANK PLAZA, SUITE 3500, ST LOUIS, MO, 63101, US

(73) Assignee: THE CRAWFORD GROUP, INC., Saint Louis, MO (US)

(21) Appl. No.: 12/178,037

(22) Filed: Jul. 23, 2008

(51) Int. Cl. G06Q 10/00; G06Q 50/00; G06Q 40/00

(52) U.S. Cl. 705/4; 705/5; 701/29; 705/11

(57) ABSTRACT

A method and system are disclosed for managing a rental vehicle reservation wherein the need for reservation managers to follow-up with repair facilities to gain additional information about repair work to disabled vehicles can be greatly reduced if not eliminated. Upon receipt of an update from a repair facility as to repair work for a disabled vehicle that pertains to a replacement rental vehicle reservation, an appropriate set of follow-up questions is directed to the repair facility by automated processes without the need for human intervention by the reservation manager. Furthermore, to support flexibility with respect to different informational needs by different purchasers of replacement rental vehicle services, the set of follow-ups questions that is selected and directed to repair facilities can vary based on a number of parameters.

### CROSS-REFERENCE TO RELATED PATENT APPLICATIONS

This application is related to pending U.S. patent application Ser. No. 11/747,645, entitled “System and Method for Improved Rental Vehicle Reservation Management”, filed May 11, 2007, and published as U.S. Patent Application Publication 2008/0140460, the entire disclosure of which is incorporated herein by reference. This application is also related to pending U.S. patent application Ser. No. 11/609,844, entitled “Computer System for Processing Rental Car Reservations with Automated Callback Reminders”, filed Dec. 12, 2006, and published as U.S. Patent Application Publication 2007/0174081, the entire disclosure of which is incorporated herein by reference.

### FIELD OF THE INVENTION

The present invention is generally directed toward the field of rental vehicle reservation management, particularly the management of replacement rental vehicle reservations.

### BACKGROUND AND SUMMARY OF THE INVENTION

Drivers whose regular vehicles are disabled as a result of accidents or otherwise will often need to engage a rental vehicle while their regular vehicles are disabled. As the term is used herein, a vehicle may become disabled by either the driver having had an accident, thereby causing damage for a repair facility (e.g., body shop, mechanic, etc.) to fix, or by simply through mechanical failure, maintenance, or other similar desires or needs for changes requiring the custody of the vehicle to be relinquished to a repair facility. In many instances, an insurance company, automobile dealer, or fleet company will provide a rental vehicle to such drivers as part of the services provided through automobile insurance policies, dealer service policies, or fleet service policies. Such rental vehicles are referred to herein as “replacement rental vehicles” or “replacement vehicles”. Replacement rental vehicles represent an important source of business for rental vehicle service providers given the large volumes of drivers whose regular vehicles become disabled (i.e., not fully operative) as a result of accidents, mechanical breakdowns, and other causes.

In this business chain, there are four primary parties—the first is the driver whose vehicle becomes disabled (thereby creating a need for a rental vehicle), the second is the purchaser of rental vehicle services who books a rental vehicle reservation on behalf of the driver (typically an insurance company, automobile dealer, etc.), the third is the rental vehicle service provider with which the purchaser books the rental vehicle reservation, and the fourth is the repair facility/body shop where the driver's disabled vehicle is repaired.

Given that the purchaser in this business chain often bears all or a portion of the costs for the rental vehicle reservation, the purchaser is highly desirous of business partners (namely, rental vehicle service providers and repair facilities) that can provide their services in a cost-efficient manner. Thus, it is desirable for rental vehicle service providers to coordinate their services with repair facilities such that drivers and purchasers can be promptly notified when repairs to the disabled vehicles have been completed and the need for the rental vehicle services have ended. By doing so, purchasers can reduce the number of instances where they unnecessarily pay for additional days of rental vehicle services, which given the high volume nature of the replacement rental vehicle business can have a significant effect on purchasers' bottomlines.

In an effort to serve the needs of purchasers, the assignee of the present invention has pioneered the development of business systems that can be used by purchasers to create and efficiently manage replacement rental vehicle reservations, as described in U.S. Pat. No. 7,275,038, pending U.S. patent application serial numbers (1) Ser. No. 11/823,782, published as U.S. Patent Application Publication 2007/0260496, (2) Ser. No. 11/881,216, published as U.S. Patent Application Publication 2007/0271125, (3) Ser. No. 11/881,383, published as U.S. Patent Application Publication 2007/0271124, (4) Ser. No. 11/929,277, filed Oct. 30, 2007, and published as U.S. Patent Application Publication ______, (5) Ser. No. 11/929,350, filed Oct. 30, 2007, and published as U.S. Patent Application Publication ______, (6) Ser. No. 11/929,473, filed Oct. 30, 2007, and published as U.S. Patent Application Publication _______, (7) Ser. No. 09/694,050, filed Oct. 20, 2000, (8) Ser. No. 10/028,073, filed Dec. 26, 2001, and published as 2003/0125992, (9) Ser. No. 10/865,116, filed Jun. 10, 2004, and published as 2005/0091087, (10) Ser. No. 11/868,266, published as U.S. Patent Application Publication 2008/0162199, (11) Ser. No. 11/550,614, published as U.S. Patent Application Publication 2008/0097798, (12) Ser. No. 11/609,844, published as 2007/0174081, and (13) Ser. No. 11/747,645, published as U.S. Patent Application Publication 2008/0140460, and PCT patent application PCT/US01/51437, filed Oct. 19, 2001, published as WO 02/067175, and for which U.S. national phase application Ser. No. 10/343,576 is currently pending. The entire disclosures of the above-referenced patent and patent applications are incorporated herein by reference.

For example, the 2008/0140460 publication discloses a technique for increasing the automation with which term-related parameters of rental vehicle reservations can be managed by a computer system. As used herein, the phrase “term-related parameters” can be defined as those data elements of a rental vehicle reservation that are temporal in nature. Examples of term-related parameters for reservations whose values can be automatically computed in accordance with a preferred embodiment of the present invention include any or all of the following: (1) a target number of days (TD), which represents an estimate of the time needed by a repair facility to complete repairs to a disabled vehicle corresponding to a rental vehicle reservation, (2) a target completion date (TCD), which represents an estimation of the date on which a repair facility will complete repairs to a disabled vehicle corresponding to a rental vehicle reservation, (3) an authorization period for a rental vehicle reservation, which represents how long a purchaser has authorized a driver to rent a rental vehicle in accordance therewith, (4) a last authorized day or date (collectively, LAD) for a rental vehicle reservation, which represents the final day/date of the authorization period, and (5) a callback reminder date, which represents a scheduled date for a callback to be performed in connection with a rental vehicle reservation.

A “callback” refers to a communication to a party involved with a rental vehicle reservation to obtain information as to the status of some aspect of a rental vehicle reservation. Callbacks are typically performed at various times throughout the authorized term of a rental vehicle reservation. Callback communications can take the form of electronic data communications (emails, automated data transfers, faxes, etc.) or telephone calls. Callbacks are also preferably categorized into a plurality of different types, such as types that are defined by the recipient of the callback (e.g., repair facility callbacks, driver callbacks, purchaser callbacks, etc.). Callbacks can be performed by any of the parties involved in a rental vehicle reservation, but it is typically the case that a callback will be performed by an employee of the rental vehicle service provider (or by a computer system of the rental vehicle service provider) or by an employee of the purchaser (or by a computer system of the purchaser).

Purchasers such as insurance companies employ large numbers of personnel such as insurance adjusters to perform the day-to-day tasks of creating and managing replacement rental vehicle reservations. Among the burdens on adjusters as part of the reservation management process is deciding upon an appropriate authorization period for each rental vehicle reservation and then taking action to extend the authorization period for rental vehicle reservations as appropriate in the event of delays in repairs to the drivers' damaged vehicles. In addition to these reservation-related burdens, insurance adjusters must also perform a variety of other tasks as part of the insurance claims handling process, such as providing accurate descriptions as to the nature of loss and negotiating with insureds, claimants, and repair facilities regarding issues such as the value of loss and the repair costs. As explained hereinafter, the preferred embodiment of the present invention can help reduce adjusters' rental vehicle reservation-related burdens, thereby allowing them more time to focus on other aspects of the claims process.

It is often the case that adjusters first create a rental vehicle reservation with a rental vehicle service provider before a repair facility has been able to inspect the disabled vehicle corresponding to the reservation. Thus, adjusters, when booking the reservation, will often either set an authorization period for the reservation that is only a rough estimation as to how long the driver will actually need to rent the replacement rental vehicle or set a short authorization period to account for the amount of time expected until repair estimate information becomes available. Given that the adjuster has not yet been informed by the repair facility as to how long repairs may take for the driver's disabled vehicle, such estimations will often need to be revised after the repair facility provides the adjuster with a repair estimate for the disabled vehicle. For example, it will often be the case that the repair estimate, when received, will indicate that a longer or shorter authorization period is needed. Furthermore, it may be the case that unexpected delays will occur during the repair process (e.g., parts being on backorder, etc.), in which case another need may arise to increase the authorization period for the reservation. In all of these instances, the adjuster typically needs to stay aware of how repairs are progressing for each damaged vehicle and then make a decision as to what the appropriate authorization period for the reservation should be. As explained hereinafter, the preferred embodiment of the present invention is directed toward improving and, preferably, increasing the automation by which this process operates from the adjuster's perspective.

For example, in instances where an event in the repair process for a disabled vehicle triggers a need to consider revising an authorization period for a reservation, a purchaser may require certain information from the repair facility before revising the authorization period. Such informational requirements may vary based on a number of factors such as the type of repair process event triggering the need for revision, the particular purchaser involved with the reservation, the particular repair facility involved with the reservation, or combinations thereof.

It is believed that with previous reservation management systems, when a repair facility updated its repair status such that an extension was needed for a reservation's authorization period, follow-up telephone calls or follow-up messaging was often needed from purchaser to repair facility so that the purchaser could obtain the appropriate information requirements from the repair facility. It is further believed by the inventors these follow-up communications hindered the efficiency of the reservation management process.

In an effort to improve efficiency, the inventors herein disclose a technique, preferably embodied by computer software, for ensuring that repair facilities provide the information needed by a reservation manager to properly manage a reservation in response to any updates to the repair process for the disabled vehicle that occur over time.

In this way, the need for follow-ups can be greatly reduced if not eliminated because the system can prompt repair facilities to immediately input the necessary information for delivery to a reservation manager. Thus, once the repair facility updates the system as to how repair work is proceeding for a disabled vehicle (and triggers a “follow-up” informational need), the system anticipates the follow-up questions and directly prompts the repair facility for the required information.

Thus, as one exemplary embodiment of the present invention, the inventors herein disclose a computer-implemented method for managing a rental vehicle reservation for a replacement vehicle associated with a disabled vehicle, the method comprising: (1) receiving an update corresponding to a disabled vehicle, (2) determining a purchaser for a rental vehicle reservation associated with the disabled vehicle corresponding to the received update, (3) selecting at least one required data item based at least in part on the determined purchaser, and (4) communicating a request for the at least one required data item to a computer.

As another exemplary embodiment of the invention, the inventors disclose a computer system for managing a rental vehicle reservation for a replacement vehicle associated with a disabled vehicle, the computer system being configured to: (1) receive an update corresponding to a disabled vehicle, (2) determine a purchaser for a rental vehicle reservation associated with the disabled vehicle corresponding to the received update, (3) select at least one required data item based at least in part on the determined purchaser, and (4) communicate a request for the at least one required data item to another computer.

As yet another exemplary embodiment of the invention, the inventors disclose a computer-readable medium for managing a rental vehicle reservation for a replacement vehicle associated with a disabled vehicle, the computer-readable medium comprising a code segment executable by a processor, the code segment configured to (1) receive an update corresponding to a disabled vehicle, (2) determine a purchaser for a rental vehicle reservation associated with the disabled vehicle corresponding to the received update, (3) select at least one required data item based at least in part on the determined purchaser, and (4) communicate a request for the at least one required data item to a computer, wherein the code segment is resident on the computer-readable medium.

Preferably, the update comprises a repair status for the disabled vehicle. Also, the computer which receives the communicated request preferably comprises a repair facility computer, and the required data item comprises an answer to a question directed to a repair facility for the disabled vehicle.

Furthermore, it should be noted that, with an exemplary embodiment, the system can maintain a plurality of different required data items, and each required data item can be associated with one or more purchasers. Each required data item can also be associated with one or more different types of updates. Thus, to assemble a request for a given update to a disabled vehicle, the exemplary system would preferably determine a purchaser associated with that update and query a database using the update and the determined purchaser as constraints. The required data items which are associated with both of those constraints would then be included in the request. In this way, each purchaser can utilize its own set of required data items.

Further still, a given purchaser such as an insurance company may have relationships with a large number of repair facilities. The purchaser may have a closer working relationship with some repair facilities than with others. As a result of such differing levels of relationships, the purchaser may want to request different pieces of information from repair facilities depending on which repair facility is involved. To accomplish such capability with an exemplary embodiment, the system can also be configured to associate one or more of the required data items with at least one repair facility. In this manner, the exemplary system can also use the relevant repair facility as a constraint when querying the database for the appropriate required data items to be included in the request.

In one exemplary embodiment, the request is communicated to the repair facility computer via a graphical user interface (GUI) screen, preferably accessed by the repair facility over the Internet and through a web browser. Preferably, once a user of the repair facility computer enters a repair status for the disabled vehicle into a GUI screen displayed through the web browser, the system operates to refresh that GUI screen to display the request for the required data items (along with one or more input fields for user entry of those data items). As used herein, the term “refresh” in the context of a GUI screen includes not only a traditional GUI screen “refresh”, but also an immediate GUI screen update in response to user interaction such as that provided through Asynchronous JavaScript and XML (Ajax) technology. Such immediate GUI screen updates can be characterized as an HTML injection into the currently displayed GUI screen.

In another exemplary embodiment, the request is communicated to the repair facility as a web service request. In this way, the repair facility need not access a GUI screen provided by the system to provide a response to the request. Through the use of web services technology, a repair facility can either utilize its own user interfaces to prompt users for required data items or software resident on the repair facility computer can automatically obtain the required data items from available vehicle repair data stored by the repair facility computer. The repair facility computer can then communicate its response to the web service request as a web service response.

In yet another exemplary embodiment, the repair facility computer has a data pump installed thereon to automatically communicate vehicle repair data to a server, wherein this vehicle repair data includes at least a subset of the required data items. The system can then access the server to obtain those required data items that are within the communicated vehicle repair data. For any required data items that cannot be accessed through the server, the system can communicate a request for such data items to the repair facility computer (preferably for response by a user of the repair facility computer).

As another exemplary embodiment of the invention, the inventors disclose a computer-implemented method for managing a rental vehicle reservation for a replacement vehicle associated with a disabled vehicle, the method comprising: (1) receiving an update corresponding to a disabled vehicle, (2) selecting at least one required data item based at least in part on the received update, and (3) communicating a request for the at least one required data item to a computer. A corresponding computer system and computer-readable medium is also disclosed.

In still another exemplary embodiment of the invention, the inventors disclose that the responses to the request for required data items can be collected in a database and used to generate useful reports that provide valuable comparative data as to how repair work proceeds across a large number of repair facilities.

In addition to easing the burdens on reservation managers, the preferred embodiment of the present invention also provides purchasers with consistency and accuracy with respect to how their reservation management policies are implemented because it is expected that the number of instances where reservation managers approve extension requests without having obtained the requisite information from repair facilities will be greatly reduced.

While the principal advantages and features of several embodiments of the invention have been discussed above, a greater understanding of the invention including a fuller description of its other advantages and features may be attained by referring to the drawings and the detailed description of the preferred embodiment which follow.

### BRIEF DESCRIPTION OF THE DRAWINGS

FIG. 1 depicts an exemplary process flow for automating the computation of term-related parameters for rental vehicle reservations on the basis of received vehicle repair data;

FIGS. 2(a) and (b) depicts preferred embodiments for the process flow of FIG. 1;

FIGS. 3(a)-(e) illustrate exemplary rules for computing term-related parameters for rental vehicle reservations on the basis of vehicle repair data;

FIGS. 4(a)-(c) illustrate exemplary rules for automatically scheduling callback reminders for rental vehicle reservations;

FIG. 5 depicts an exemplary process flow for automatically scheduling callback reminders on the basis of a set of callback scheduling rules;

FIGS. 6 and 7 depict exemplary computer system architectures for sharing information among a plurality of parties involved with a replacement rental vehicle reservation in accordance with a preferred embodiment of the present invention;

FIG. 8 depicts an exemplary embodiment for the automated reservation management computer system;

FIG. 9 depicts another exemplary embodiment for the automated reservation management computer system;

FIG. 10 depicts yet another exemplary embodiment for the automated reservation computer management system;

FIGS. 11(a) and (b) depict exemplary embodiments for graphical user interface (GUI) screens through which users such as repair facility personnel can submit changes in repair estimate times to a rental calculator;

FIGS. 12(a) and (b) depict exemplary screenshots of an GUI generated as an exemplary input mechanism for input of required data;

FIGS. 13(a)-(i) conceptually depict an exemplary data requirements specification and how data items within a data requirements specification can be associated with different entities;

FIG. 14 depicts various relationships in an exemplary embodiment wherein a purchaser can define the data requirement applicable to various situations;

FIG. 15 depicts an exemplary data requirements specification associated with a trusted repair facility, and an exemplary data requirements specification associated with a less-trusted repair facility;

FIG. 16 depicts an embodiment wherein multiple purchasers are associated with a single data requirements specification;

FIGS. 17(a)-(g) depict exemplary process flows in various embodiments wherein the system selects a data requirement specification;

FIG. 18 depicts an exemplary embodiment wherein the reservation management computer system employs an audit report generator to generate audit reports based on the information received from repair facilities;

FIG. 19 depicts an exemplary audit report that could be produced by the embodiment of FIG. 18;

FIG. 20 depicts an exemplary GUI screen for listing scheduled callback reminders;

FIG. 21 depicts an exemplary GUI screen for a reservation wherein a message is included which informs a reservation manager that the driver's disabled vehicle has been repaired and it is ready for pickup;

FIG. 22 depicts an exemplary GUI screen that lists action items for a reservation manager, including an extension authorization request produced at step 216 of FIG. 2(a) or (b);

FIG. 23 depicts an exemplary GUI screen through which a reservation manager can extend a reservation; and

FIG. 24 depicts another preferred embodiment for the process flow of FIG. 1, wherein the vehicle repair data may include both labor hours data and an estimated completion date.

### DETAILED DESCRIPTION OF THE PREFERRED EMBODIMENTS

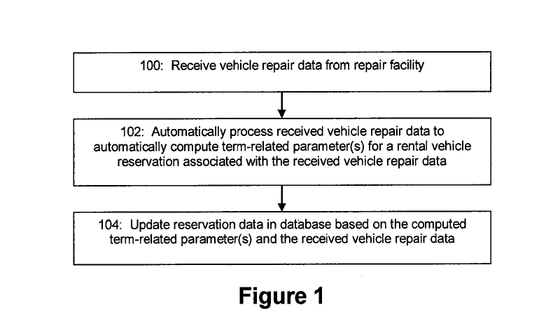

FIG. 1 depicts an exemplary process flow for automating the computation of term-related parameters for rental vehicle reservations on the basis of received vehicle repair data. Preferably, the process of FIG. 1 is performed by a rental calculator, wherein the rental calculator preferably takes the form of a software program executed by a rental vehicle reservation management system, as explained in greater detail hereinafter.

At step 100, vehicle repair data is received from a repair facility. The received vehicle repair data, which corresponds to the disabled vehicle of a driver who has a replacement rental vehicle reservation, may be defined as that information regarding the various materials, processes, and/or services required to repair or otherwise restore the disabled vehicle to service. As examples, the vehicle repair data can take the form of repair estimates, repair orders, or other formats for vehicle repair status information. As should be understood in the art, many repair facilities utilize standardized formats for data contained within repair estimates and/or repair orders (e.g., the CIECA Estimate Management System (EMS) standard for data within repair estimates), and the vehicle repair data may optionally be received from repair facilities in these formats. The repair facility can communicate such vehicle repair data to the rental calculator in any of a number of ways, including but not limited to: (1) automated data transfers from the repair facility computer system to the rental calculator, (2) data entered by repair facility personnel through a GUI screen displayed on a repair facility computer system wherein the GUI screen interfaces the repair facility personnel with the rental calculator, and/or (3) emails, faxes, and/or telephone calls from repair facility personnel to personnel of a rental vehicle service provider or other entity who in turn keys the vehicle repair data included in the email/fax/telephone call into the rental calculator, etc. The above-referenced and incorporated 2008/0162199 publication describes how vehicle repair data can be automatically transferred from a repair facility computer system to a reservation management computer system. It should also be understood that the vehicle repair data can be communicated from the repair facility computer system to the rental calculator by way of information providers such as CynCast, Mitchell, Autowatch, and other entities who provide systems and services to repair facilities in connection with collision repair transactions.

At step 102, the rental calculator preferably operates to automatically process the received vehicle repair data to automatically compute at least one term-related parameter for the rental vehicle reservation corresponding to the disabled vehicle that is the subject of the received vehicle repair data. A preferred term-related parameter that is automatically computed at step 102 is the TCD for repairs to the disabled vehicle. Preferably, the length of authorization for the replacement rental vehicle reservation corresponding to the disabled vehicle will not exceed the TCD so as to minimize unnecessary rental vehicle costs for the purchaser of the replacement rental vehicle reservation. However, the rental calculator may employ purchaser-specific business rules to determine how closely the reservation's authorization length should correspond with the TCD. Thus, another preferred term-related parameter that can be automatically computed at step 102 is the authorization period and/or LAD for the replacement rental vehicle reservation. Once again, purchaser-specific rules can be employed by the rental calculator to determine a reservation's authorization period and/or LAD. Yet another term-related parameter that can be automatically computed at step 102 is a callback reminder date for a reservation. An automated callback scheduler, preferably embodied as a software program, such as that described in the above-referenced and incorporated U.S. Patent Application Publication 2007/0174081, can be called by the rental calculator to automatically schedule callback reminders for a reservation in response to the received vehicle repair data.

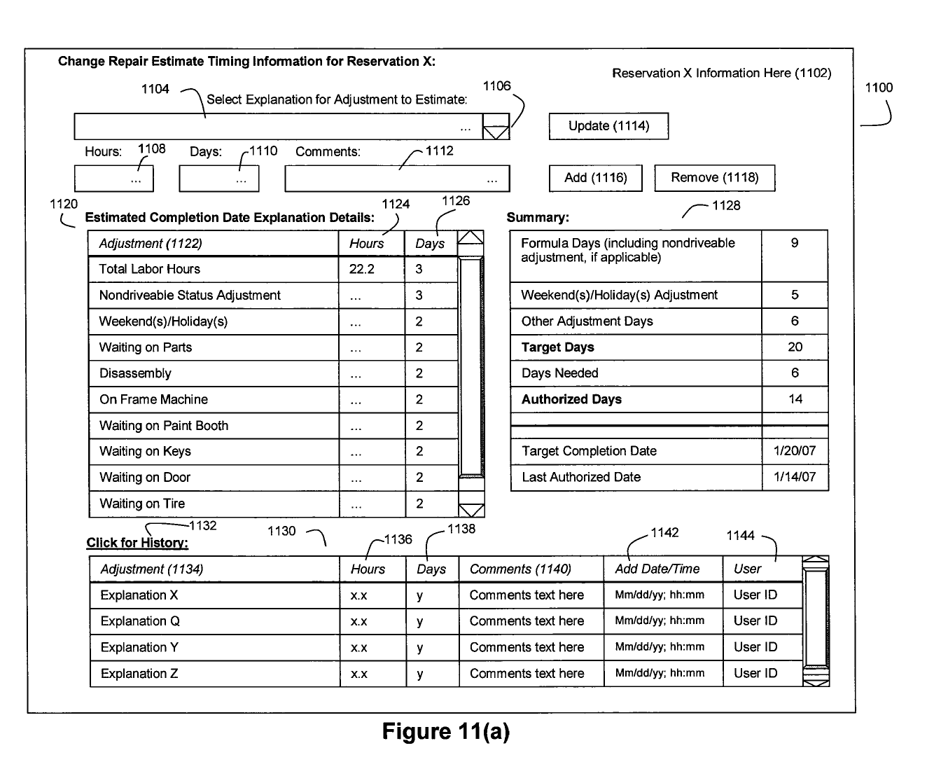

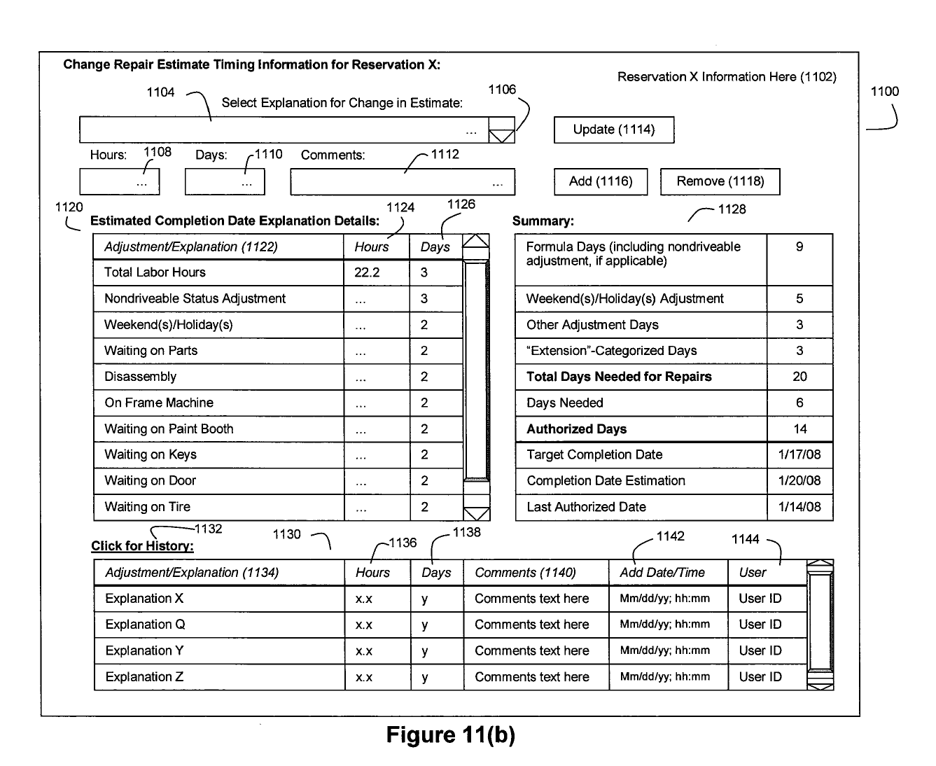

It should be noted that in one embodiment, the flow of FIG. 1 from step 100 to step 102 can occur automatically. That is, following receipt of the vehicle repair data in step 100, the process proceeds to the automated computation of step 102 without human intervention. In another embodiment (e.g., as described hereinafter with respect to the GUI screen 11 of FIGS. 11(a) and (b)), the process can proceed from step 100 to the automated computation of step 102 after intervention by a reservation manager or other party.

Following step 102, the rental calculator preferably updates a database in which the reservation data is stored to thereby reflect the newly computed term-related parameters for the reservation (step 104).

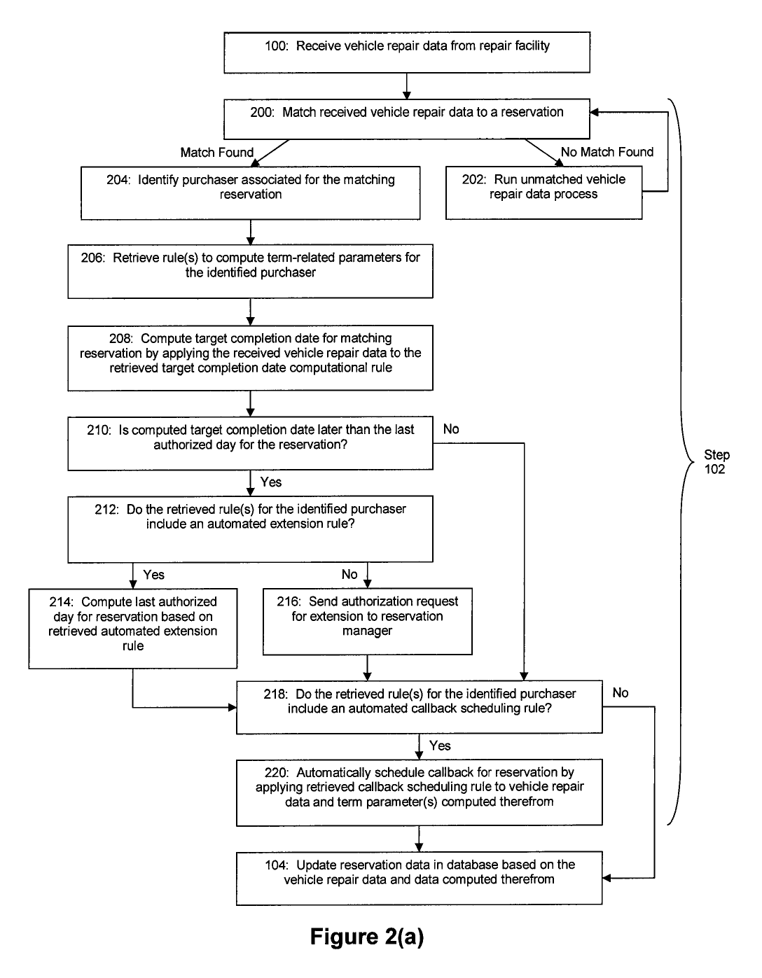

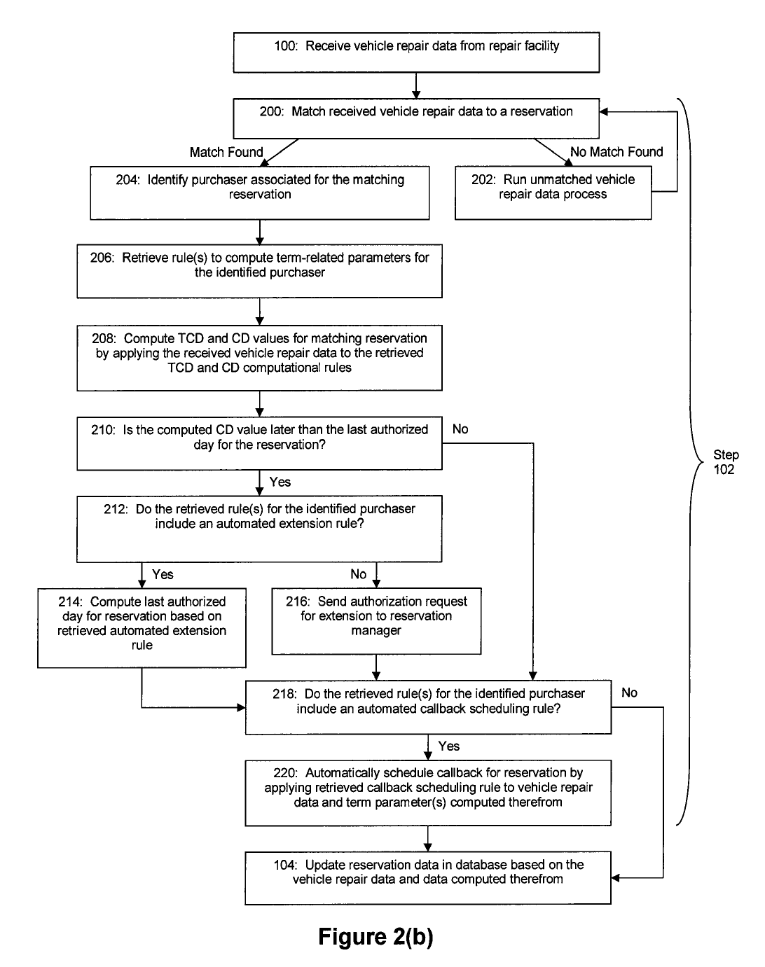

FIG. 2 depicts step 102 of FIG. 1 in greater detail. At step 200, the rental calculator attempts to match the received vehicle repair data to an existing reservation within the rental vehicle reservation management system. If no match is found, at step 202 the rental calculator preferably runs an unmatched vehicle repair data process. Preferably, this unmatched vehicle repair data process maintains a list of vehicle repair data for vehicles that do not find a match in an existing reservation. As subsequent rental vehicle reservations are created within the reservation management system in response to actions by purchasers or employees of the rental vehicle service provider, these new reservations are compared against the unmatched vehicle repair data on the list to check for matches. If a match is found at step 200, then at step 204 the rental calculator retrieves the reservation file corresponding to the received vehicle repair data and identifies the purchaser for that reservation. As should be understood, each reservation file preferably identifies the purchaser for the reservation (e.g., an insurance company, an automobile dealership, a vehicle fleet company, etc.).

The reservation management system preferably maintains a plurality of business rules that define how the term-related parameters should be computed for each purchaser. Thus, at step 206, the rental calculator preferably retrieves the business rule(s) for computing the term-related parameters that are applicable to the purchaser identified at step 204. Then, at step 208, the rental calculator processes the received vehicle repair data to compute the target number of days (TD) for the reservation in accordance with the retrieved business rules. A preferred computational formula for the term-related reservation parameter TD is:

TD=┌f(r)+WH(i,f(r),RSD)┐ (1)

wherein f(r) represents a function of the received vehicle repair data r, and wherein WH(i,f(r),RSD) represents a weekends and holidays adjustment as defined for the purchaser i and based on the function f(r) and the reservation start date (RSD). It should be noted that the ceiling function ┌ . . . ┐ can optionally be applied to each component of the TD formula rather than to the aggregation of the components, if desired. A preferred formula for f(r) is:

$$f ( r ) = \frac{LH}{LHS ( i )} + ND ( i ) + A ( i , r ) \qquad ( 2 )$$

wherein LH represents the number of labor hours estimated by the repair facility to repair the disabled vehicle (as defined in the received vehicle repair data), wherein LHS(i) represents a labor hours scalar defined for the purchaser i, wherein ND(i) represents an adjustment for nondriveable disabled vehicles as defined for the purchaser i, and wherein A(i,r) represents other adjustments defined for the purchaser i on the basis of the received vehicle repair data r.

The value of the labor hours scalar is preferably selected to scale the number of labor hours to a number of days that will be needed to perform those labor hours on the disabled vehicle. As indicated, the value of LHS can be defined on a purchaser-by-purchaser basis. However, it should also be noted that the value of LHS can optionally be defined on a repair facility-by-repair facility basis or some combination of a purchaser and repair facility basis. Also, when first computing TD for a reservation, it should be noted that the value of A(i,r) is expected to be zero as A(i,r) is provided to serve as a term for updating the value of TD in response to events that occur throughout the repair process.

TD is preferably expressed as an integer, preferably in units of days. However, it should be noted that other units (e.g., hours) could be used. The value for TCD can be readily computed from TD by adding the computed TD value to the RSD.

Thus, if a repair facility initially estimates that 48 labor hours would be needed to complete repairs to a given disabled vehicle, and if the labor hours scalar for the applicable purchaser is 6, then the LH/LHS component of TD will result in a need for 8 days.

Further still, a purchaser may want to further adjust the TD value based on whether the disabled vehicle is driveable or nondriveable. Reservations corresponding to nondriveable disabled vehicles will typically be of a longer duration than reservations corresponding to driveable disabled vehicles. One reason for this circumstance is that a driver of a nondriveable disabled vehicle will need to pick up his/her replacement rental vehicle immediately because of the nondriveable nature of his/her disabled vehicle. Thus, the driver's replacement rental vehicle reservation will have started even though the repair facility may have not yet ordered and/or received the parts necessary to repair the nondriveable disabled vehicle. With a driveable disabled vehicle, however, the driver can often wait to take the disabled vehicle into the repair facility for repairs until after the repair facility has ordered and received the parts necessary to perform the necessary repairs. In such cases, the lag time for a repair facility to order and receive parts is often not included in the reservation duration for driveable vehicles, while such a lag time is often included in the reservation duration for nondriveable vehicles. Thus, continuing with the example, it will be assumed that the driver's disabled vehicle is nondriveable, and the purchaser's defined nondriveable adjustment is 3 days. Thus, the f(r) component of TD will initially compute to a value of 11 days (as explained, the value of the A(i,r) term during the initial TD computation is likely zero).

Furthermore, given that 11 days is longer than a week, this time span must include at least one weekend and possibly one or more holidays. Thus, depending on how the purchaser defines a weekends and holidays adjustment, then additional days may be added to TD. It should be noted that purchasers can define the weekends and holidays adjustment values on a repair facility-by-repair facility basis to match the repair facilities' business practices, if desired. Furthermore, it should be noted that the rental calculator preferably also computes the weekends and holidays adjustment based on the RSD to account for reservation time spans that encompass weekends and/or holidays. For example, if the RSD is Dec. 31, 2007, and it is assumed for purposes of this example that Dec. 31, 2007 falls on a Thursday, then a value of 11 days from f(r) will encompass three weekends (January 2-3, January 9-10, and January 16-17) and two holidays (New Years and MLK Day—January 1 and the third Monday in January, respectively). In such a circumstance, the weekends and holidays adjustment may need to account for the three weekends (rather than just a single weekend) and the two holidays. Therefore, continuing with the example wherein the RSD is Thursday, Dec. 31, 2007, if the purchaser adds two days to TD for each weekend spanned by the f(r) amount and one day for both the New Years and MLK day holidays, then WH(i,8, Dec. 31, 2007) would be 8. This, in turn, increases the value of TD to 19. Therefore, with a TD value of 19, the TCD would fall 19 days after the RSD, for a TCD of Jan. 19, 2008.

At step 210, the rental calculator then compares the TCD with the LAD for the reservation to determine whether the TCD falls on a date after the LAD. If the TCD falls before the LAD, then no extensions need to be made to the reservation, and the rental calculator proceeds to step 218, described hereinafter. However, if the TCD falls after the LAD, then it may be necessary to extend the reservation to accommodate the fact that the driver's disabled vehicle may not be ready for pick up at the repair facility until after the reservation has ended. Thus, at step 212, the rental calculator preferably checks the retrieved rules for the purchaser to identify whether the purchaser has authorized automated extensions in the event of shortfalls in the LAD relative to the TCD. If the purchaser has authorized automated extensions in such circumstances, then at step 214 the rental calculator automatically computes the LAD value for the reservation based on the automated extension rule for the purchaser. While the automated extension rules can be based on multiple variables, it is expected that in many situations a purchaser will want to automatically extend the reservation to the TCD, in which case the LAD value for the reservation is populated with the TCD value computed at step 210. If the purchaser has not authorized automated extensions, then at step 216 the rental calculator preferably instructs the reservation management system to send an authorization request for an extension to the reservation manager (e.g. an insurance adjuster for an insurance company purchaser or a rental company employee who has been tasked with some aspect of managing the subject reservation). This authorization request preferably informs the reservation manager of the difference between the TCD and the LAD and asks the reservation manager to extend the reservation as appropriate. As explained above and below, approval of such an authorization request by the reservation manager may be contingent on the repair facility satisfying the information requirements for the authorization request.

At step 218, the rental calculator checks whether the retrieved rules for the purchaser include any automated callback scheduling rules. If the purchaser does not have any automated callback scheduling rules, then the rental calculator preferably proceeds to step 104, where the updated TCD (and possibly LAD) data is stored in the database for the reservation. Otherwise, the rental calculator proceeds to step 220. At step 220, the rental calculator calls an automated callback scheduler such as the one described in the above-referenced and incorporated U.S. Patent Application Publication 2007/0174081 to automatically schedule at least one callback reminder for the reservation by applying the applicable callback scheduling rules to the computed TCD value (and possibly the computed LAD value) and/or the received vehicle repair data. The scheduled callback reminder(s) can also be stored for the reservation in the database at step 104.

Now, assume that 4 days after the RSD, new vehicle repair data is received from the repair facility at step 100, wherein the new vehicle repair data indicates that an additional time should be added to the TCD because of some explanation for delay in repairs (e.g., a parts supplier has informed the repair facility that a part needed for the repairs is on backorder). In such a case, the rental calculator will process the newly received vehicle repair data r as shown in FIG. 2. At step 208, it should be noted that the value of the A(i,r) term in the formula for TD will no longer be zero. In this example, the value of A(i,r) would be derived from the newly received vehicle repair data r (e.g., a derived value of 2 days). Thus, the new TCD for the reservation would be Jan. 21, 2007. Presuming that the LAD was changed to Jan. 19, 2007 as a result of processing the initially received vehicle repair data, then steps 210-216 preferably operate to adjust the LAD by an additional two days, and steps 218-220 preferably operate to adjust the scheduled callback reminders as appropriate. This process is preferably automatically repeated each time that new vehicle repair data is received from a repair facility at step 100.

By automating the processes performed by the rental calculator in FIG. 2, the inventors herein believe that the burdens placed on personnel such as insurance adjusters to manage replacement rental vehicle reservations can be greatly alleviated, thereby providing significant improvement in efficiency to purchasers such as insurance companies.

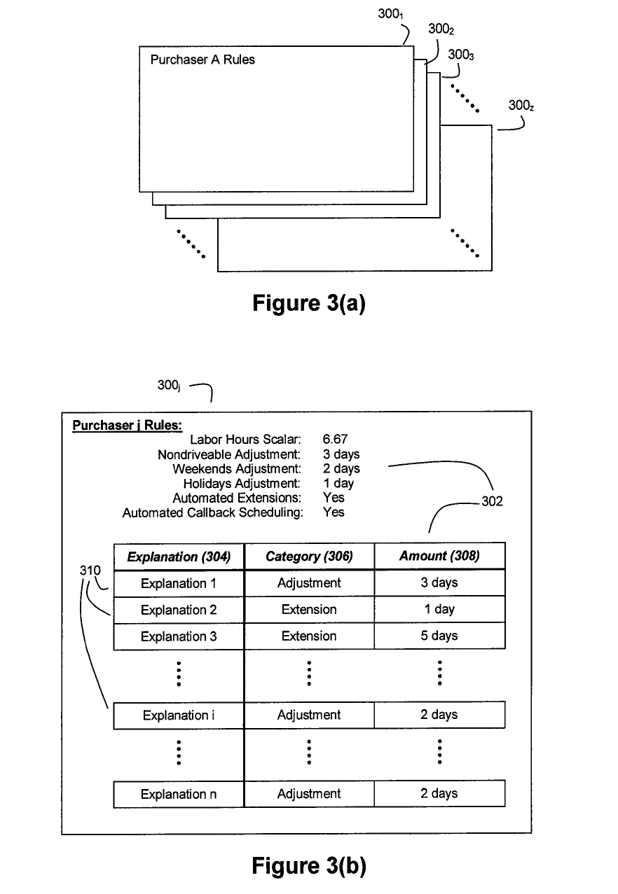

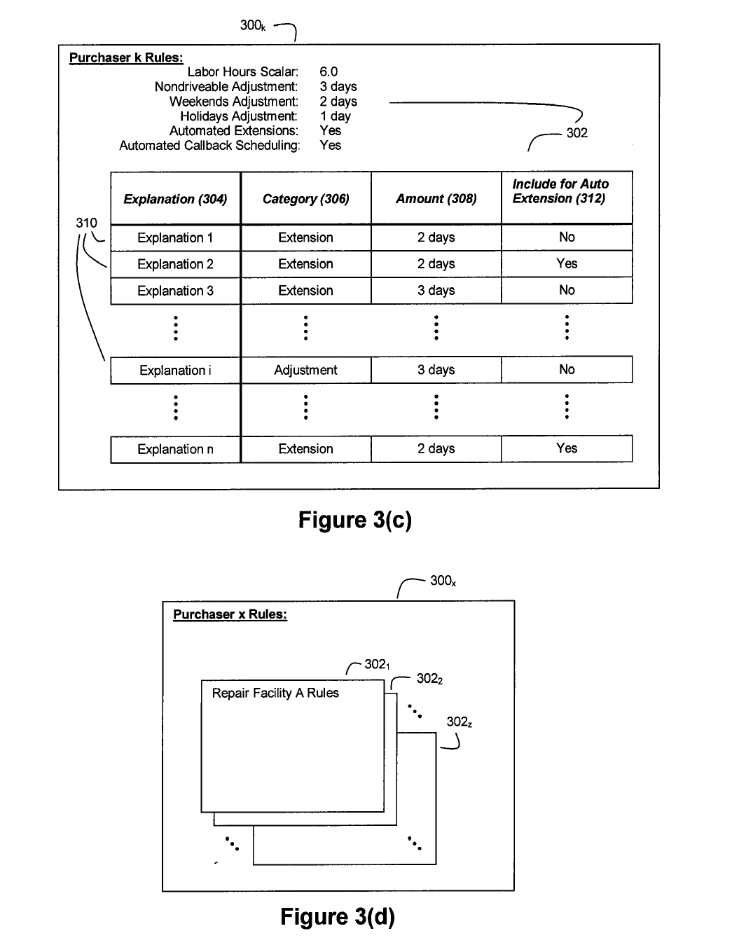

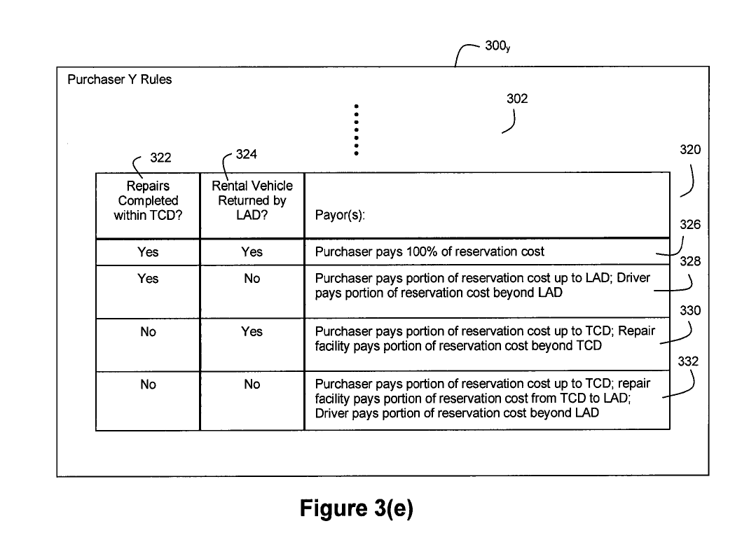

FIG. 3(a) depicts how the rules used by the rental calculator of FIG. 2 can be defined on a purchaser-by-purchaser basis. As shown in FIG. 3(a), rule set 300₁ can be applicable to purchaser A, while rule set 300₂ is applicable to purchaser B, while rule set 300₃ is applicable to purchaser C, and so on until rule set 300_{z} for purchaser Z. Thus, when the rental calculator reaches step 206 for purchaser i, it can retrieve rule set 300ᵢ that is associated with that purchaser.

Each purchaser rule set preferably includes the rules that govern how the TCD is computed, whether/how automated extensions are to be applied, and whether/how callback reminders are to be automatically scheduled. For example, FIG. 3(b) depicts a rule set 300ⱼ for purchaser j. Rule set 300ⱼ preferably comprises rules 302 that (1) define the labor hours scalar (LHS) for the purchaser, (2) define the nondriveable adjustment (ND) for the purchaser, (3) define the weekend portion of the weekends/holidays adjustment (WH) for the purchaser, (4) define the holiday portion of the weekends/holidays adjustment (WH) for the purchaser, (5) define whether and how automated extensions are to be carried out for the purchaser, (6) whether and how callbacks are to be automatically scheduled for the purchaser, and (7) define how the other adjustments (A) are to be computed for the purchaser.

For the purpose of computing the other adjustments (A) values, rules 302 preferably include rules tables such as that shown in FIG. 3(b). This table preferably includes a column corresponding to an explanation/reason 304 for a change in the TD estimate (e.g., “waiting on parts”, “disassembly”, “waiting on tires”, etc.). Optionally, these explanations/reasons can correspond to the standardized CIECA status update message codes as well as other pre-defined explanations for repair status updates. For each listed explanation/reason 310, the table preferably defines an amount of delay 308 for that explanation/reason. The value in amount column 308 preferably serves as the value for A in the f(r) function of equation (2) when the repair facility provides the corresponding explanation/reason 310.

Optionally, the table also includes a category column 306 that defines whether each listed explanation/reason 310 is to be treated as an adjustment or an extension. If treated as an adjustment, the amount 308 corresponding to the explanation/reason 310 is preferably included in the A term for f(r) to adjust the target number of days. If treated as an extension, the amount 308 corresponding to the explanation/reason 310 is preferably not included in the A term for f(r), and an extension will be needed for the reservation to account for a delay in repairs due to that explanation/reason. When processing an explanation/reason 310 that is categorized as an extension rather than an adjustment, processing flow can be added to the rental calculator that will send an authorization request for an extension to the purchaser in response to the received explanations/reasons categorized as extensions, as shown in the alternate embodiment of FIG. 2(b). For example, a new term “Completion Date” (CD), which corresponds to the date on which the repair facility expects to complete repairs, could be computed as follows:

CD=┌f′(r)+WH(i,f′(r),RSD)┐ (3)

wherein f′(r) is computed as

f′(r)=f(r)+E(i,r) (4)

wherein E(i,r) represents the extension amount needed for the explanations categorized as “extensions” as defined by the rules 302 of FIG. 3(b). In the process flow of FIG. 2(b), step 208 preferably operates to calculate both the TCD and CD values for the reservation, but step 210 preferably compares with CD value with the LAD to determine whether an extension is needed since the TCD, in this embodiment, will not necessarily be indicative of the full amount of time that the repair facility will actually need to repair the subject disabled vehicle.

It should also be noted that the CD value could alternatively be calculated according to the formula:

CD=┌TCD+E(i,r)┐ (5)

in which case the weekends and holidays adjustment will remain unaffected by the explanations categorized as “extensions”.

FIG. 3(c) depicts another exemplary rule set 300ₖ for purchaser k. As can be seen, purchaser k may define different values than purchaser j for the different rules 302.

Also, it should be understood that the rules 302 within each rule set 300ᵢ can be repair facility-specific, as shown in FIG. 3(d). In the example of FIG. 3(d), the rule set 300ₓ for purchaser x includes a plurality of different rules 302₁, 302₂, . . . 302_{z}, each applicable to a different repair facility. In this fashion, purchasers can tailor their computational rules to the business practices of the repair facilities at which disabled vehicles are sent for repairs. This can be particularly helpful in calibrating the rules 302 to account for the weekend and holidays policies of different repair facilities (e.g., some repair facilities may work 7 days per week, others only 6 days per week, while still others only 5 days per week; and different repair facilities will often close for different holidays). Thus, at step 206 in FIG. 2, the rental calculator can not only retrieve the rule set 300ᵢ corresponding to the applicable purchaser i, but also retrieve the rules 302ⱼ within rule set 300ᵢ corresponding to the repair facility j from which the vehicle repair data was received.

Optionally, the rule set 300ᵢ can also include cost distribution rules 320 that define how the cost for a rental vehicle reservation is to be split among the different parties under various circumstances, as shown in the example of FIG. 3(e). The cost distribution rules 320 preferably define a plurality of payor rules for a plurality of different combinations of term-related parameter-derived conditions. Exemplary term-related parameter-derived conditions include condition 322 and condition 324 shown in FIG. 3(e). Condition 322 is defined by whether the repair facility in question completed its repairs within the TCD computed therefor. Condition 324 is defined by whether the driver returned the rental vehicle to the rental vehicle service provider by the LAD. Rules 320 of FIG. 320 illustrate a matrix of different permutations for these conditions coupled with their corresponding payor rules 326, 328, 330, and 332. Payor rule 326 states that the purchaser will pay 100% of the reservation cost if the repair facility completes its repairs within the TCD and if the driver returns the rental vehicle by the LAD. Payor rule 328 states that the purchaser will pay for the portion of the reservation cost that accrued up to the LAD and the driver will pay for the balance when the repair facility completes its repairs within the TCD but the driver does not return the rental vehicle until after the LAD. Payer rule 330 states that the purchaser will pay for the portion of the reservation cost that accrued up to the TCD and the repair facility will pay for the balance when the repair facility does not complete its repairs within the TCD and the driver returns the rental vehicle by the LAD. Finally, payer rule 332 states that the purchaser will pay for the portion of the reservation cost that accrued up to the TCD, the repair facility will pay for the portion of the reservation cost that accrued from the TCD to the LAD, and the driver will pay for the balance when the repair facility does not complete its repairs within the TCD and the driver does not return the rental vehicle until after the LAD.

It should be noted that the cost distribution rules 320 can also be defined on a repair facility-specific basis if desired. Furthermore, different conditions can be defined for different payer rules. For example, some repair facilities may have an arrangement with a purchaser where only delays of X number of days after the TCD will trigger reservation costs being distributed to the repair facility.

In operation, the flow of FIGS. 2(a) and 2(b) could accommodate the cost distribution rules 320 of FIG. 3(e) by applying these rules to the reservation data and vehicle repair data, wherein the reservation record in the database is automatically updated to reflect how costs for the reservation are to be distributed among the different parties.

As explained in the above-referenced and incorporated U.S. Patent Application Publication 2007/0174081, is the system can also be configured with the ability to schedule callback reminders within the reservation files. The callback reminders may correspond to callbacks of any type. Exemplary types of callbacks can be defined based on the recipient of the callback, e.g., repair facility callbacks, renter (or driver) callbacks, and purchaser (or non-driver payor) callbacks. For instance, a repair facility callback may be directed to a repair facility to check on the status of a repair. As another example, a purchaser (or non-driver payor) callback may be directed to the party that has purchased the rental vehicle services or assumed the payment obligation therefor (e.g., an insurance company, automobile dealership, vehicle fleet company, etc.) to inquire about extending an authorization for a rental vehicle reservation if the LAD for a reservation is near. As still another example, a renter (or driver) callback may be directed to a driver to check on the status of the rental or to inquire about a balance due on his/her account. Each type of callback is preferably system-defined, and the callback reminders are preferably automatically generated based upon a set of business rules algorithms. The callback reminders can be displayed to a user of a reservation management system as described hereinafter, or they can be communicated to an external computer system for access by a user thereof. Such communications may optionally take the form of web service communications. A rules engine for automatically scheduling callback reminders, such as an automated callback scheduler, may be internal or external to the reservation management system so long as it is accessible thereto. Furthermore, it should be noted that the callback reminders need not be stored in the same physical database as the reservation data to which they correspond so long as the appropriate business systems can access the reservation data and scheduled callback reminders as needed.

One of the benefits of automatically scheduling callback reminders is that the automated callback scheduler can be triggered each time there is an update to the underlying rental record, as shown by way of example in the process flow of FIG. 2 wherein an update to the vehicle repair data for a reservation record can trigger the automated callback scheduler. As another example, upon detecting an update to a reservation file that indicates a renter's balance of payment is zero, an automated callback scheduler can be configured to delete any previously-scheduled renter callbacks for that reservation.

Thus, each type of callback can have a complex set of rules (or algorithm) that can be customized for a particular party (insurance company, repair facility, etc.). For example, one insurance company may want callbacks made 2 days before the end of an existing rental authorization, while another may desire 3 days advance notice. A repair facility could choose to have all repair facility callbacks be made on certain days of the week. The rules can be further customized based on a number of other variables. For instance, callbacks to check the status of repairs to a disabled vehicle could be made a specified number of days in advance of the end of an authorization depending upon whether the disabled vehicle was driveable, and further depending upon how many days exist between the last update to the callback record and the expected end of the rental. By way of another example, the rules can take into account the number of estimated repair hours the repair facility estimates will be needed.

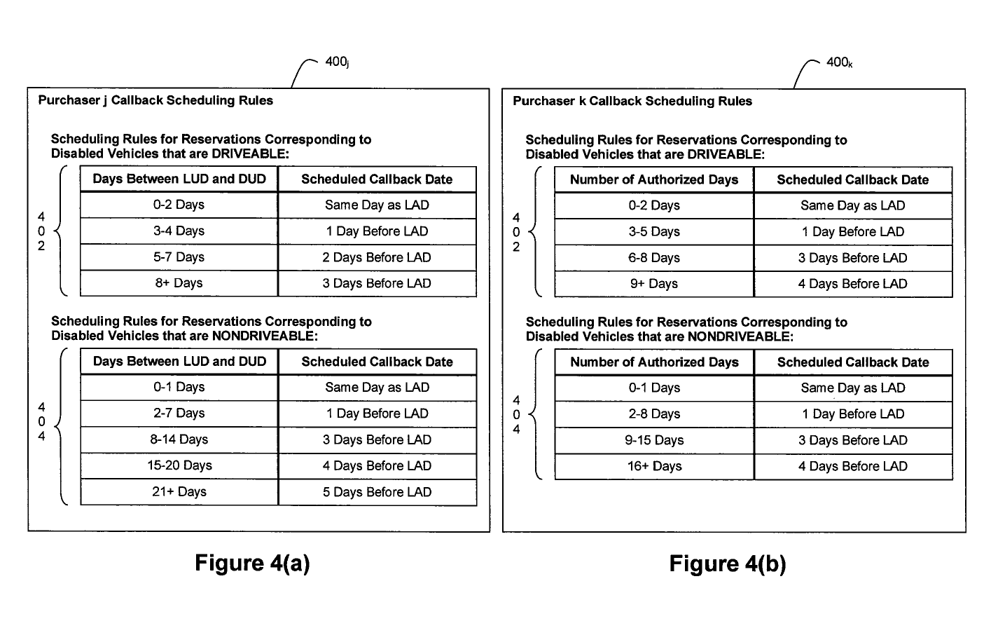

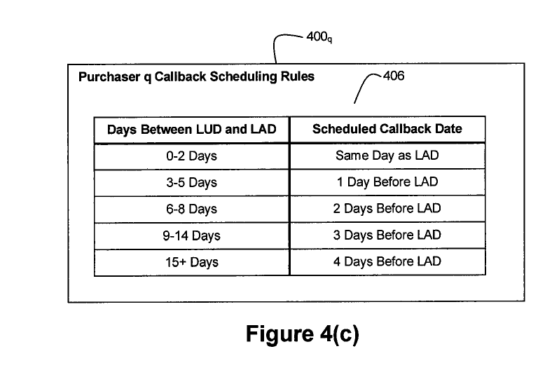

FIG. 4(a) illustrates an exemplary set of callback scheduling rules 400ⱼ that can be defined for purchaser j. In this example, purchaser j applies one set of rules 402 to repair facility callbacks corresponding to driveable vehicles and another set of rules 404 to repair facility callbacks corresponding to nondriveable vehicles. Each rule set 402 and 404 preferably identifies a measurement trigger (the left column of the table) that defines a condition for setting a callback on a given scheduled callback date (as defined by the instruction in the right column of the table). Preferably, the scheduled callback dates are expressed relative to a callback reminder reference such as the LAD. Any of a number of different measurement triggers can be used. Moreover, it should also be noted that rules 402 may use a different measurement trigger than rules 404, if desired by a practitioner of this aspect of the invention. In the example of FIG. 4(a), the measurement trigger is defined as the number of days encompassed between the “last update date” (LUD) for the reservation file and the “DUD” for that reservation, wherein the DUD represents the most recently updated date of either the TCD or the current extension date authorized by the insurance company (the LAD). Depending on where this number falls within the breakdowns defined in the table, a different callback date will be scheduled.

FIG. 4(b) depicts another exemplary set of callback scheduling rules 400ₖ for purchaser k. In the example of FIG. 4(b), the measurement trigger is the number of authorized days for the reservation. As with the example of FIG. 4(a), different rules 402 and 404 are provided for disabled vehicles that are driveable and nondriveable.

FIG. 4(c) depicts another exemplary set of callback scheduling rules 400_{q} for purchaser q. In the example of FIG. 4(c), the measurement trigger is defined as the number of days encompassed between the LUD and the LAD for the reservation. Furthermore, the automated callback scheduling rules for purchaser q do not distinguish between driveable and nondriveable vehicles.

It should be appreciated that a limitless number of different algorithms can be created and entered into the automated callback scheduler, with a great deal of flexibility.

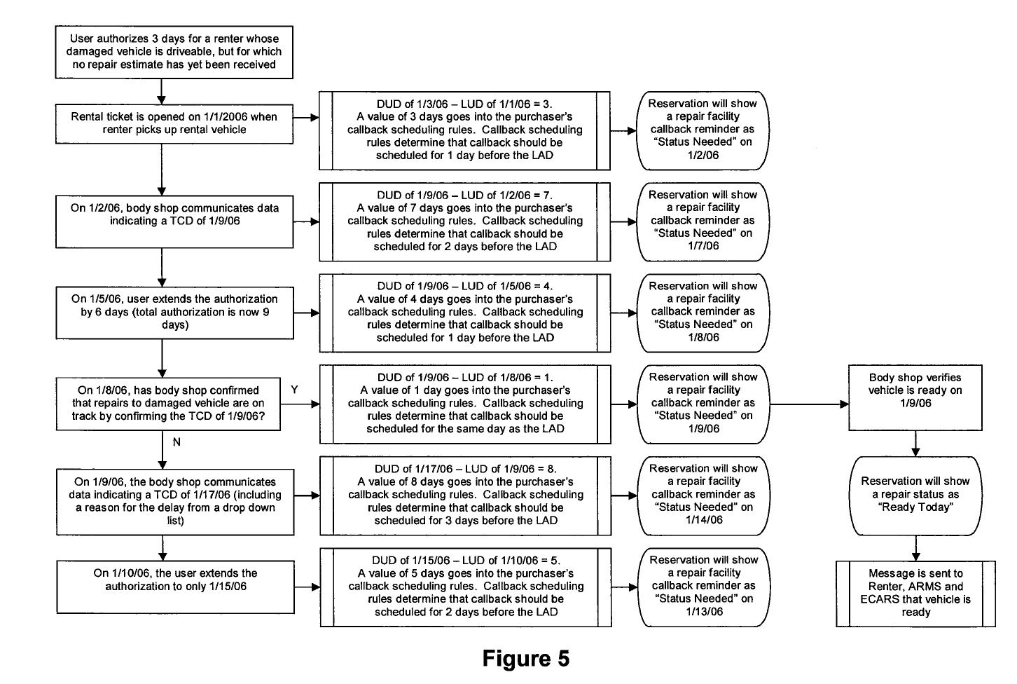

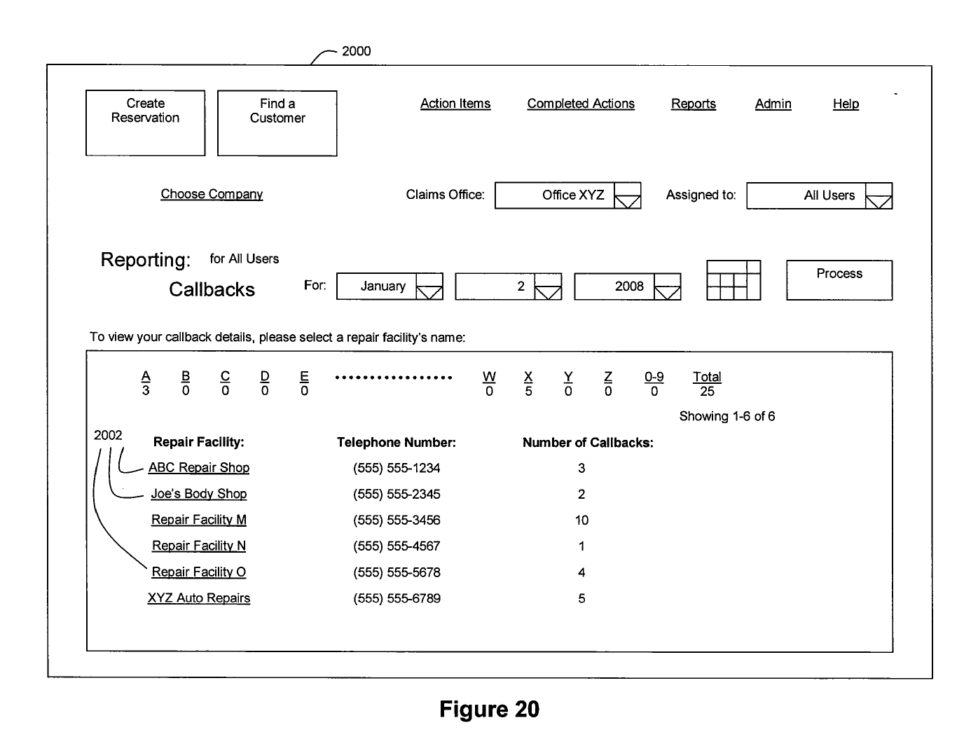

FIG. 5 shows a sample algorithm flow for an automated callback scheduler showing both the flexibility of the automated scheduling and the ability to update the callback reminders each time a record is updated. In the process flow of FIG. 5, the automated callback scheduler will use the rule set 400ⱼ of FIG. 4(a). For each scenario the number of days between the LUD for the reservation and the DUD is computed as the measurement trigger. In the flowchart example, a purchaser such as an insurance company authorizes a rental for 3 days on January 1 so that a repair estimate can be obtained on repairs to the renter's driveable vehicle. As the reservation record is opened, the LUD is January 1 and the DUD is January 3 (as defined by the LAD because the TCD is yet undefined). The number of days, inclusive, between DUD and LUD is 3, and this value is used as the measurement trigger. Referring to the driveable rules 402 of the rule set 400ⱼ of FIG. 4(a), a callback reminder is set for 1 day before the LAD, which would be January 2. FIG. 20 illustrates an exemplary “callbacks” screen that can be displayed by a reservation management computer system to a reservation manager on January 2, wherein the system automatically adds a repair facility callback reminder 2002 to the list of scheduled repair facility callback reminders 2002 for January 2 as a result of the automated callback scheduling rules. Upon selection by the reservation manager of one of the repair facilities listed as a repair facility callback reminder, preferably a GUI screen is displayed that lists the reservations for which the repair facility callback is applicable. Upon selection by the reservation manager of one of these listed reservations, preferably a callback details screen is displayed. Preferably this screen includes fields such as those shown in FIG. 11(a) or 11(b) described hereinafter. Based on information learned from a repair facility as a result of the repair facility callback, the reservation manager can fill out the appropriate fields of the callback details screen, which in turn may trigger the process of FIG. 2(a) or 2(b) if the updated information contains new vehicle repair data.

Returning to the flow of FIG. 5, on January 2 the repair facility indicates that TCD will be January 9. If the callback for January 2 has not yet been made, the reminder therefor would now be updated, or else a new callback reminder would be set. In either case, the updated/new callback reminder would be based on a new DUD of January 9 (the TCD) and a new LUD of January 2. With 7 days between the DUD and LUD, the callback reminder will be set for 2 days before the LAD, or January 7.

On January 5 the insurance company extends the authorization by 6 days, thereby setting the LAD to January 9. As can be seen, in this example, the insurance company has not employed an automated extension to match the LAD to the TCD as the TCD becomes available. The automated callback scheduler processes the reservation record again and updates the callback reminder based on a new LUD value of January 5. With 4 days between the new LUD and the DUD, the callback reminder is reset for one day before the LAD, which is January 8.

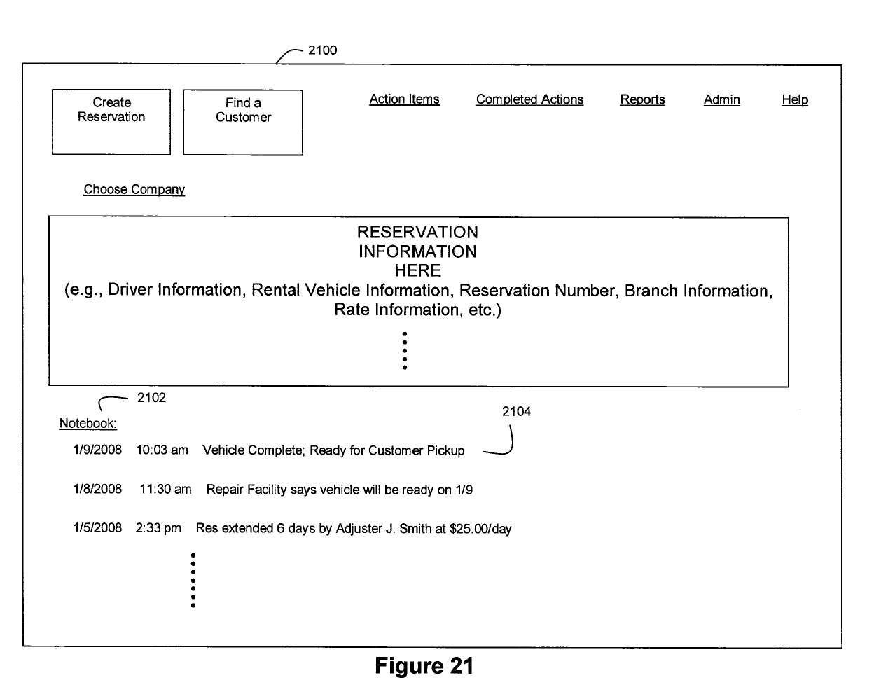

On January 8 the insurance company takes action on the scheduled callback reminder and performs a repair facility callback to check on the status of the vehicle repair. If the repair facility confirms the vehicle will be ready on January 9, the reservation record is updated (because a callback was made) and a new callback reminder is set for January 9 (the same day as the LAD, because there is only 1 day between the DUD and the new LUD). On January 9 another callback is made to the repair facility confirming that the renter's regular vehicle is ready, in which case a message is sent to the renter and the reservation management system is updated accordingly. In such an instance, as shown in FIG. 21, a GUI screen 2100 displayed to a reservation manager concerning the subject reservation preferably includes a message 2104 in a notebook section 2102 that informs the reservation manager that the repairs to the disabled vehicle are complete and it is ready for pickup by the customer. It should also be noted that optionally the “vehicle ready for pickup” message can be displayed to a reservation manager through an “action items” GUI screen of a reservation management system.

In the event the repair facility indicates a delay—in the example shown the repair facility indicates a delay until January 17 and provides a reason for the delay—a new callback reminder is automatically generated. This time the DUD value is January 17 and the LUD is January 9. With 8 days between the two variables, the reminder is set for 3 days before the LAD, which is January 14.

Then supposing on January 10 the insurance company extends the authorization, but only until January 15, the existing callback reminder is automatically updated using a DUD of January 15 and an LUD of January 10, thereby resulting in a callback reminder set for January 13.

It should be noted that, optionally, the reservation management system can be configured to execute callbacks automatically on the scheduled callback reminder date. For example, if a repair facility callback is scheduled for July 1, then when July 1 is reached, the reservation management system can be configured to generate and send a message to the repair facility inquiring about the repair status for a disabled vehicle corresponding to the subject reservation.

It should also be noted that, as described in the above-referenced and incorporated U.S. Patent Application Publication 2008/0140460, the inventive system can also be configured to generate audit reports that provide a wide range of metrics data about the reservations managed by purchasers and the repairs performed by repair facilities.

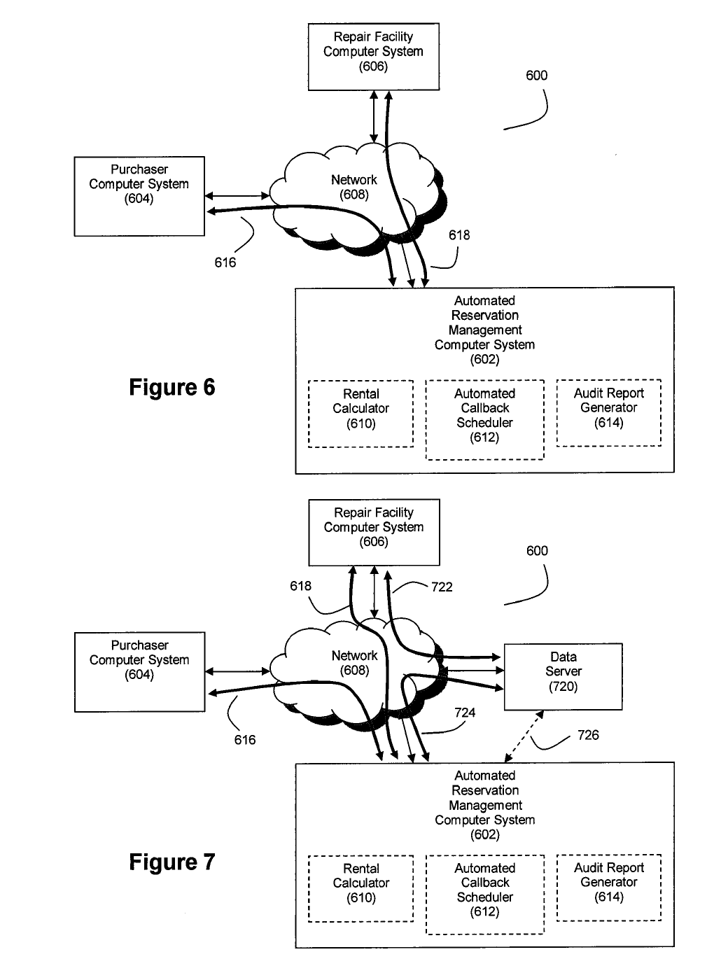

FIGS. 6 and 7 depict system architectures 600 that illustrate how the different parties to the replacement rental process can exchange information with each other. In the example of FIG. 6, an automated reservation management computer system 602 is in communication with a purchaser computer system 604 and a repair facility computer system 606 over a network 608 such as the Internet. The automated reservation management computer system 602 can take the form of the ARMS® system developed by the assignee of this invention and as described in the above-referenced and incorporated patent and patent applications. While only one purchaser computer system 604 and one repair facility computer system 606 are shown in FIGS. 6 and 7 in communication with the automated reservation management computer system 602 over network 608, it should be readily understood that a plurality of purchaser computer systems 604 and a plurality of repair facility computer systems 606 can communicate with the automated reservation management computer system 602 over network 608.

As shown in FIG. 6, preferably the rental calculator 610, automated callback scheduler 612, and audit report generator 614 are resident within the automated reservation management computer system 602 and executed thereby. However, it should be noted that any or all of the rental calculator 610, the automated callback scheduler 612, and the audit report generator 614 can optionally be deployed on other computer systems within system 600, including but not limited to the purchaser computer system 604, the repair facility computer system 606, and the data server 720 (see FIG. 7). Further still, it should be noted that the functionality of the rental calculator 610, the automated callback scheduler 612, and/or the audit report generator 614 can be distributed across and shared by different computer systems within system 600 if desired by a practitioner of the invention.

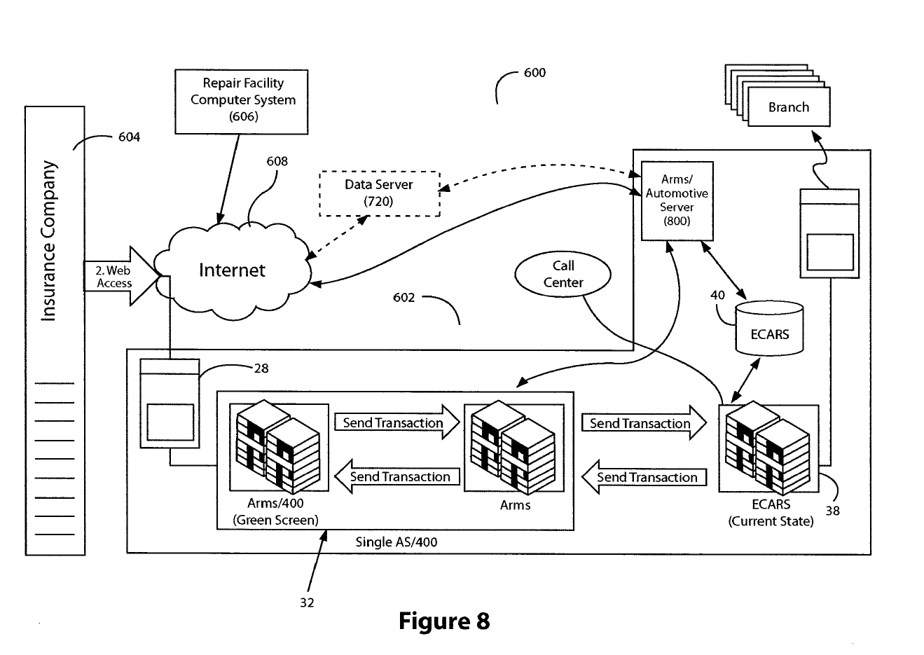

FIG. 8 illustrates an exemplary embodiment for the automated reservation management computer system 602. Functionality for this embodiment of the automated reservation management computer system 602 is described in greater detail in the above-referenced and incorporated U.S. Pat. No. 7,275,038. As described therein, a user of the purchaser computer system 604 can access a plurality of GUI screens through Internet web portal 28, wherein these GUI screens interface the purchaser with software executed on mainframe 32 that allows the purchaser to create and manage rental vehicle reservations with a rental vehicle service provider. A database 40 can store the reservation data where it is accessible to a fulfillment software program resident on mainframe 38. The fulfillment software program is preferably accessible to a plurality of branch office computers that are operated by employees of the rental vehicle service provider from branch offices where vehicles are available for rent. Thus, when a driver for a replacement rental vehicle reservation arrives at the branch location to pick up his/her replacement rental, the fulfillment software program is executed to update the reservation records in the database 40 to indicate the opening of a rental ticket for the reservation. Through the GUI screen interface provided via web portal 28, the purchaser can continue to manage the reservation as the reservation continues. It should be understood that the term “rental vehicle reservation” as used herein is not meant to be limited to only the creation of a reservation, but is meant to encompass all aspects of the reservation process, from the initial creation of the reservation, to the opening of a rental ticket when the driver picks up a rental vehicle in accordance with the reservation, to the period while the driver has control of the rental vehicle, and to the closing of the rental ticket when the driver returns the rental vehicle to the rental vehicle service provider (including the invoicing of the costs for the completed reservation).

The automated reservation management computer system 602 can include a server 800 that is in communication with the repair facility computer system 606 (and/or data server 720) via network 608. Optionally, the rental calculator 610 can be deployed on the server 720 to act in response to any received vehicle repair data. However, it should be understood that the rental calculator 610, automated callback scheduler 612, and audit report generator 614 can be deployed on any or all of the components of system 602 (e.g., mainframe 32, mainframe 38, Internet web portal 28, etc.) if desired by a practitioner of the present invention.

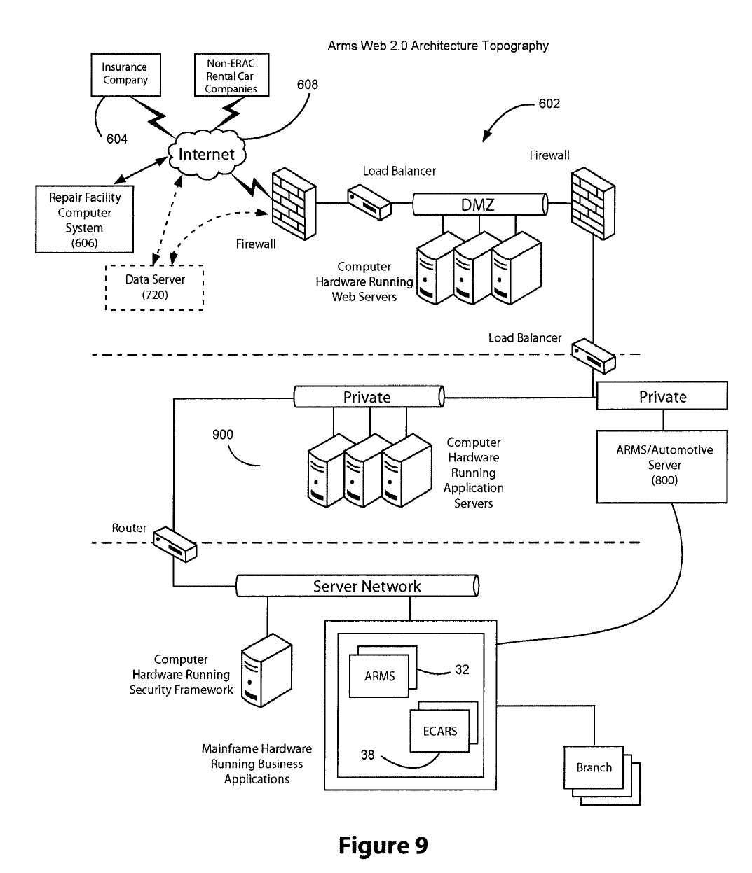

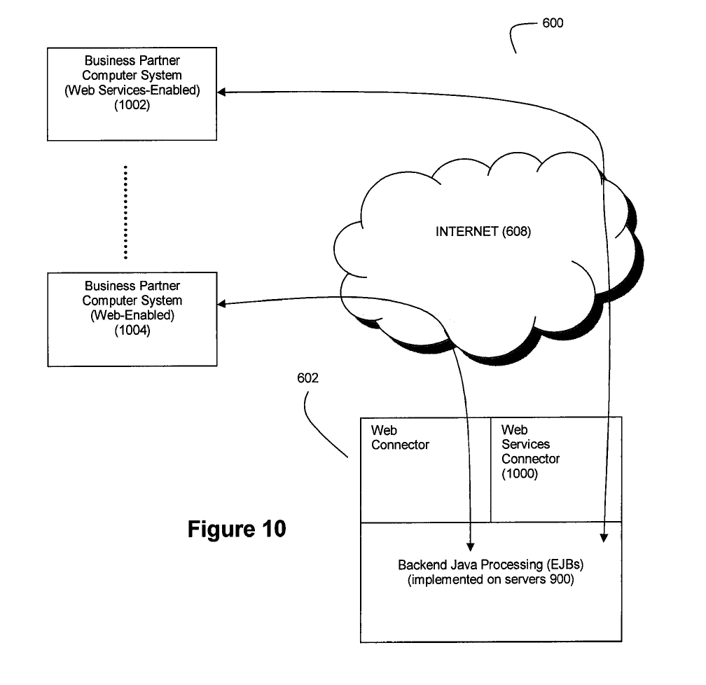

FIG. 9 illustrates another exemplary embodiment for the automated reservation management computer system 602. Functionality for this embodiment of the automated reservation management computer system 602 is described in greater detail in the above-referenced and incorporated Ser. No. 09/694,050 application. As described therein, a plurality of servers 900 in a middle architectural level of the automated reservation management computer system 602 can be configured to provide the GUI screens to the purchaser computer system 604 over network 608 (albeit through a first architectural layer that connects to network 608 through a firewall). It is also worth noting that with the embodiment of FIG. 10, a purchaser can book rental vehicle reservations not only with the rental vehicle service provider that operates computer system 602 but also optionally with a plurality of competitive rental vehicle service providers, as described in the referenced and incorporated Ser. No. 09/694,050 application. The rental calculator 610, automated callback scheduler 612, and audit report generator 614 can optionally be deployed on any of the components of computer system 602 (e.g., servers 900, mainframe 32, mainframe 38, server 800, etc.).

FIG. 10 illustrates yet another exemplary embodiment for the automated reservation management computer system 602. Functionality for this embodiment of the automated reservation management computer system 602 is described in greater detail in the above-referenced and incorporated U.S. Patent Application Publication 2005/0091087. As described therein, web services technology can be used as the mode of data exchange between a business partner computer system 1002 (e.g., purchaser computer system 604 and/or repair facility computer system 606) and the automated reservation management computer system 602. To support this functionality, the automated reservation management computer system 602 preferably employs a web services connector 1000 for connecting web services-enabled business partners 1002 with the back end processing provided by components such as servers 900 of FIG. 9. Additional details about the web services connector 1000 are described in greater detail in the referenced and incorporated 2005/0091087 publication. To business partners who are only web-enabled, their computer systems 1004 can still communicate with the back end processing of the computer system 602 via a web connector (such as the first architectural layer shown in FIG. 9). In the embodiment of FIG. 10, the rental calculator 610, automated callback scheduler 612, and audit report generator 614 can optionally be deployed on any of the components of computer system 602 (e.g., servers 900, mainframe 32, mainframe 38, server 800, the web connector, the web services connector 1000, etc.).

Returning to FIG. 6(a), through data path 616, the automated reservation management computer system 602 is preferably configured to provide a plurality of GUI screens for display within a web browser running on a computer within the purchaser computer system 604. Through these GUI screens, a user of the purchaser computer system 604 (such as an insurance adjuster if the purchaser is an insurance company) can preferably access software within the automated reservation management computer system 602 to create and manage a plurality of replacement rental vehicle reservations for various insureds and/or claimants to insurance policies provided by the insurance company.

Through data path 618, the automated reservation management computer system 602 is preferably configured to receive vehicle repair data from the repair facility computer system 606. Also, it should be noted that the automated reservation management computer system 602 can be configured to communicate repair facility callbacks to the repair facility computer system 606 over data path 618. As previously explained in connection with FIGS. 1 and 2, upon receipt of vehicle repair data, the automated reservation management computer system 602 can execute the rental calculator 610 and the automated callback scheduler 612 to automatically update the TCD (and the LAD, if the automated extensions feature of the preferred embodiment is employed by the purchaser) as well as callback reminder(s) for a reservation without requiring personnel of the purchaser or rental vehicle service provider to manually change the TCD (and the LAD, if the automated extensions feature of the preferred embodiment is employed by the purchaser) or the callback reminder schedule for the reservation. Moreover, even if the purchaser does not employ automated extensions, the rental calculator 610 can automatically send an authorization request for an extension to the purchaser if a difference is detected between the computed TCD value and the reservation's current LAD, thereby allowing the purchaser to stay on top of reservation management tasks without burdening the purchaser with the task of manually interpreting the vehicle repair data provided by repair facilities.

Furthermore, through data path 616, the purchaser can invoke the audit report generator 614 via one or more GUI screens to thereby obtain audit reports as described in the referenced and incorporated 2008/0140460 publication. Similarly, repair facility personnel can also optionally obtain audit reports from the audit report generator 614 through data path 618 if desired.

FIG. 7 depicts an alternate architecture 600, wherein a data server 720 is also in communication with the network 608. In the embodiment of FIG. 7, the repair facility computer system 606 is configured to send its vehicle repair data to the automated rental vehicle reservation management computer system 602 by way of data server 720. Thus, over data path 722, the repair facility computer system 606 can communicate vehicle repair data to the data server 720, and the data server 720 can send the vehicle repair data (or data derived therefrom) to the automated reservation management computer system 602 over data path 724 (or optionally direct communication link 726). Data path 618 can still be used as the path over which callback data is exchanged. In such an embodiment, it may be desirable to deploy all or a portion of the functionality of the rental calculator 610, the automated callback scheduler 612, and/or the audit report generator 614 on the data server 720.

As previously indicated, vehicle repair data can be communicated from the repair facility to the automated reservation management computer system 602 in any of a number of ways. For example, one manner by which repair facilities can communicate vehicle repair data to the automated reservation management computer system 602 is via a data pump installed on the repair facility computer system 606 to automatically “pump” new vehicle repair data to the automated reservation management computer system 602, as disclosed in the above-referenced and incorporated published patent application 2008/0162199.

Another manner by which the automated reservation management computer system 602 can receive vehicle repair data over data path 618 is through a GUI screen interface wherein one or more GUI screens interface a user of the repair facility computer system with the rental calculator 610, automated callback scheduler 612, and/or audit report generator 614.

FIG. 11(a) depicts an exemplary GUI screen 1100 through which repair facility personnel can submit updated vehicle repair data to the rental calculator 610 and/or automated callback scheduler 612. Screen 1100 preferably includes a section 1102 that displays various information about the reservation corresponding to the vehicle being repaired. Through field 1104, the user can enter an explanation for changing the estimated time needed to complete repairs to the disabled vehicle. Preferably, a drop down menu mechanism is provided with field 1104 to display a list of predefined explanations for user selection. This list of predefined explanations can correspond to CIECA status update message codes or other reasons as defined by purchasers and/or repair facilities. Thus, the user can select one or more of the explanations from the list to trigger a change to the time estimate needed to complete repairs. Upon selection of the explanation via field 1104, fields 1108 and 1110 are preferably automatically populated to identify the hours and/or days of additional time that corresponds to the selected reason, based on the rules 300ᵢ defined for the purchaser i associated with the reservation. Similarly, comments field 1112 is preferably automatically populated with text that describes the selected explanation, as defined by the purchaser rules 300. Furthermore, a user can optionally also enter values in fields 1108, 1110 and 1112 that are independent of the predefined explanations if a reason exists for the estimate change that does not correspond to any of the predefined explanations.

Once the user has selected an appropriate explanation, he/she can select the update button 1114 to submit the updated vehicle repair data to the rental calculator 610. If the user wishes to add a plurality of explanations to the reservation record, he/she can select the add button 1116 to add another explanation to the reservation record. If a user wishes to remove a previously-selected explanation, he/she can do so upon selection of the remove button 1118.

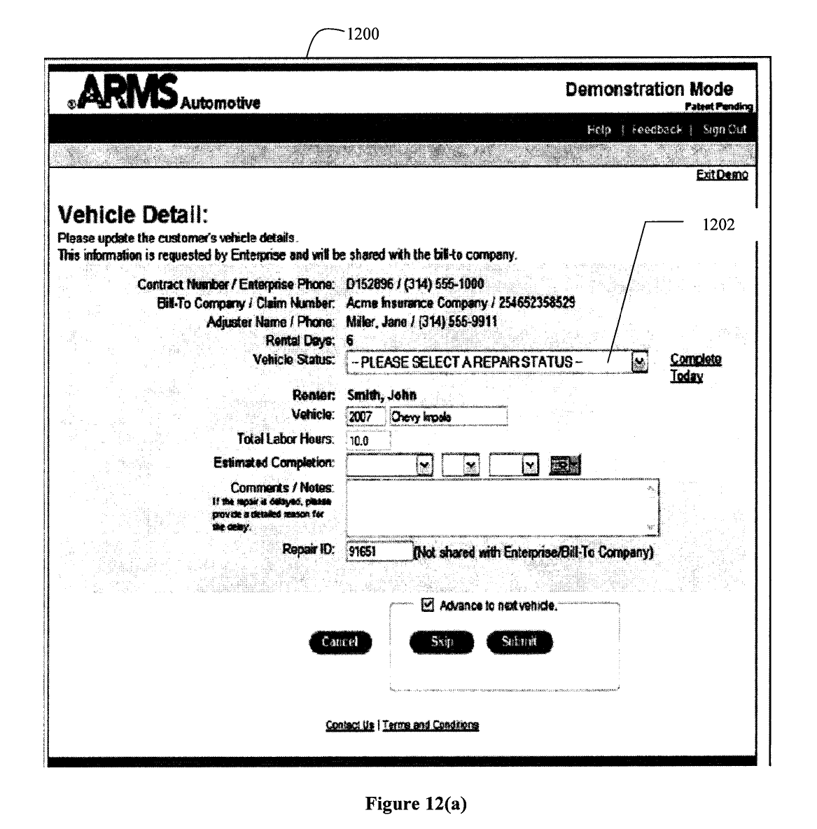

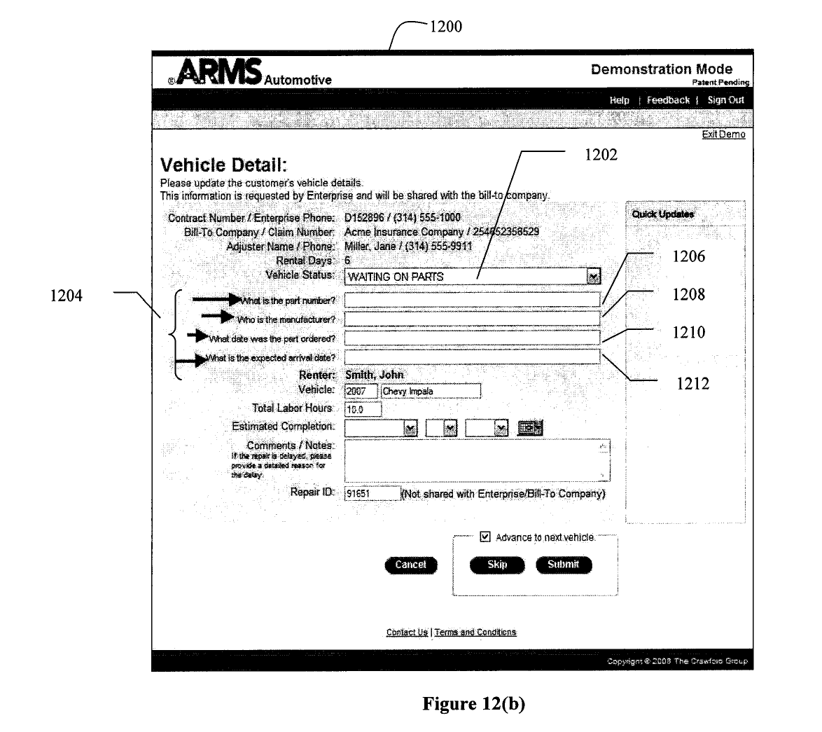

In accordance with an embodiment of the present invention, user selection of an explanation in field 1104 will trigger a need for the user to enter various pieces of information that satisfy an information requirement which corresponds to details surrounding the explanation that are desired by the reservation manager. FIGS. 12(a) and (b) depict an exemplary GUI screen 1200 that is configured with such features. When a user first accesses GUI screen 1200 to provide an update (e.g., the repair status) for a particular vehicle which is tied to a replacement rental vehicle, the user will need to enter an update explanation in field 1202 (which corresponds to field 1104 in FIG. 11(a)).

Upon user entry of an explanation for vehicle repair status in field 1202, the GUI screen 1200 is preferably refreshed such that a user input section 1204 is displayed therewithin, as shown in FIG. 12(b). As noted above, this GUI screen refresh may optionally take the form of a traditional “refresh”, wherein the browser issues a request to the server for a new version of that screen to be provided for display. However, the inventors note that this “refresh” may also take the form of an immediate GUI screen update in response to user interaction with the current GUI screen. For this purpose, Ajax programming techniques may be employed to expedite the display of section 1204 on screen 1200. User input section 1204 preferably comprises at least one user input field, with the user input field prompting the user for the data items required by the reservation manager in connection with the explanation/repair status within field 1202.

It should be noted that each purchaser may have a different set of required data items for a given repair update, as explained below. The set of required data items for a particular repair update will be referred to herein as a “data requirement specification” (DRS). In the example of FIG. 12(b), it can be seen that the DRS for the “Waiting on Parts” explanation/repair status comprises 4 required data items: (1) the part number for which the repair facility is waiting (requested via field 1206), (2) the manufacturer for the pertinent part (requested via field 1208), (3) the date on which the pertinent part was ordered by the repair facility (requested via field 1210), and (4) the expected arrival date for the pertinent part (requested via field 1212). Thus, when the user updates a disabled vehicle's repair status with the explanation “Waiting on Parts”, then user input section 1204 will request the user to also enter these 4 data items for submission to the reservation manager. As noted, this DRS is only exemplary and different purchasers may have different DRSs for the “Waiting on Parts” explanation/status.

It should be noted that, while for the example given above the update that triggers the DRS request corresponds to a repair status, the repair facility need not have already begun repairs on or even planned to repair the disabled vehicle to provide an update to the system. For example, the update from the repair facility may be an update to the effect of “the disabled vehicle is not in our shop”, which in turn may trigger its own DRS to request data items that may assist the reservation manager in locating the disabled vehicle.

It should also be noted that the system can optionally be configured to present section 1204 only if the user's explanation/status meets a particular condition. For example, one condition could be whether the status/explanation would cause a need for an extension of the authorization period for the reservation. In such an instance, the DRS preferably corresponds to the information needed by the reservation manager to approve an authorization request for an extension. As noted, different purchasers may have different information requirements for approving such requests. As another example, the system can optionally be configured to present section 1204 only if the needed extension would not be granted automatically (see steps 212 and 216 in FIGS. 2(a) and (b)) by the rental calculator 610. Preferably, when deciding whether to approve such an authorization request from a repair facility, the reservation manager can review the DRS answers provided by the repair facility. For another example, the display of section 1204 can be conditioned on a rental calculator determining that a new TCD for repair work to the disabled vehicle is later than the previous TCD. As yet another example, the condition can be related to the estimated cost for repair work. If the repair status update would indicate that the cost for the repair work will likely exceed some threshold related to a previous estimate for the repair work, then the system can be configured to cause the display of section 1204 on screen 1200. The threshold can be defined in any of a number of ways. For example, the threshold can be set to match a previous repair cost estimate, in which case any increase in the estimated repair cost would trigger the display of section 1204. Alternatively, the threshold can be set as some percentage of the previous cost estimate such that a new estimated repair cost which exceeds the previous estimated repair cost by X % would trigger the display of section 1204.

Returning to FIG. 11(a), table 1120 lists each explanation 1122 for a change to the repair time estimate that has been applied to the subject reservation, including a corresponding amount of hours 1124 and/or days 1126 of adjustment needed due to each explanation. For purposes of illustration, a large number of entries and corresponding adjustment amounts are shown in table 1120. It should be noted that the data shown in table 1120 is illustrative only and does not necessarily bear on the summary information presented in table 1128 described hereinafter. However, it should be understood that in practice, table 1120 should provide a detailed “component” level view of the information summarized in table 1128.

Summary table 1128 lists a summary of the component values within the TD calculation according to formulas (1) and (2), as well as identifications of the TCD, LAD, number of authorized days, and any shortfall between the LAD and TCD for the reservation. In this example, it can be seen that the TCD falls 6 days after the LAD, in which case an extension (or a request for an extension) to the reservation is necessary as per steps 210-216 of FIG. 2(a). As the user enters explanations via field 1104 (or fields 1108, 1110, and/or 1112), preferably the rental calculator 610 updates the summary table 1128 to reflect the changes.

History table 1130 lists a history of updates that have been made for the reservation with respect to the computations based on formulas (1) and (2). Each entry in table 1130 preferably comprises a previously-entered explanation 1134, the amount of hours 1136 and/or days 1138 corresponding thereto, any comments 1140 corresponding to the explanation in column 1134, the date and time 1142 at which the explanation in column 1134 was added to the reservation record, and an identification 1144 of the user who added the explanation in column 1134 to the reservation record. Link 1132 is preferably user-selectable to display the history information of table 1130 in a pop-up window.

FIG. 11(b) depicts another embodiment for GUI screen 1100, wherein table 1120 lists the different explanations 1122, wherein those explanations are categorized as either “adjustments” or “extensions” as per FIG. 2(b) and FIGS. 3(b)-(c) as explained above. Thus, with screen 1100 of FIG. 11(b), the CD value computed via formulas (3) and (4) will also be computed to take any “extension”-categorized explanations into consideration. As reflected in summary table 1128 of FIG. 11(b), rows can be added to the table to identify the extensions amount E from formula (4) (3 days in this example), which count toward the CD value (identified as “Total Days Needed for Repairs” in table 1128) but not toward the TCD value.

It should be noted that the user who accesses screen 1100 of FIG. 11(a) or (b) need not necessarily be a repair facility employee. For example, in some instances the user of screen 1100 may optionally be an employee of the rental vehicle service provider or the purchaser who keys in the updated vehicle repair information provided to him/her via email, fax, or a telephone call.

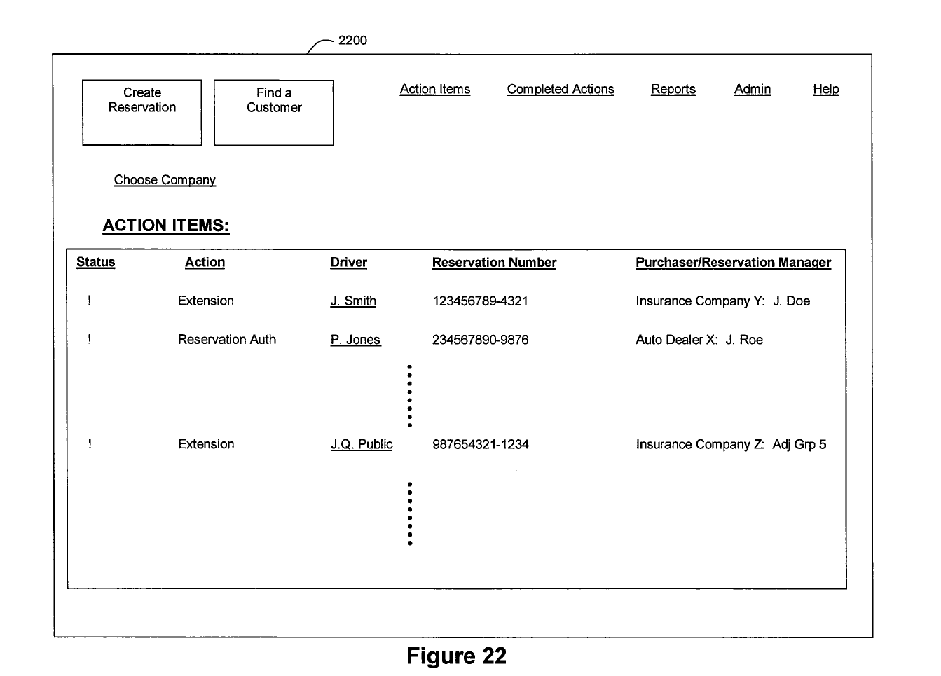

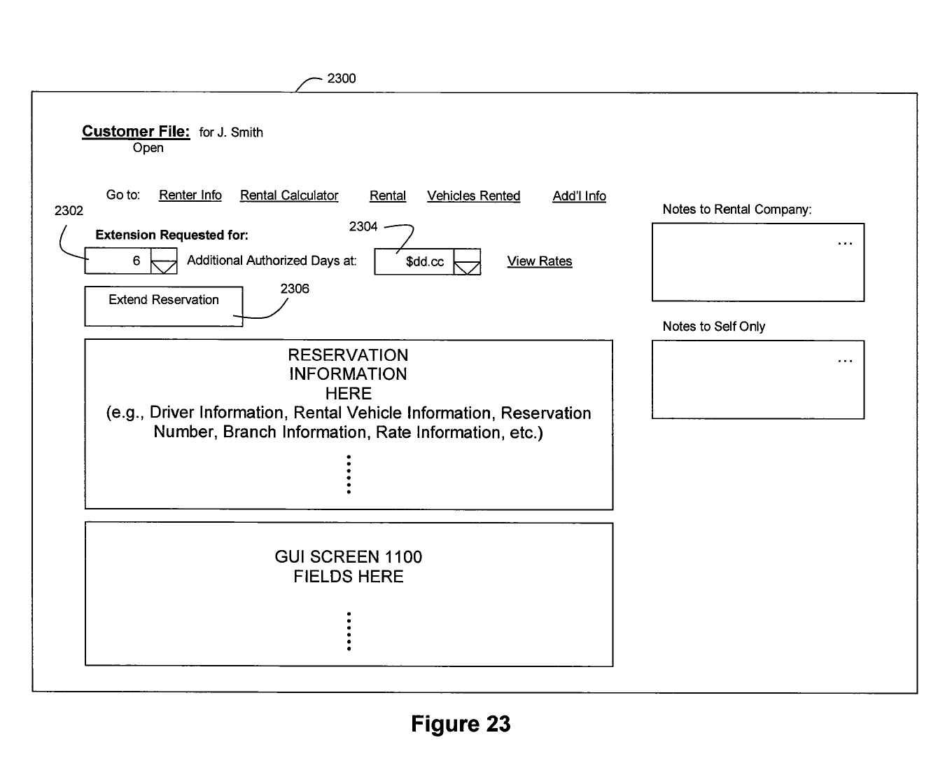

With reference to the flows of FIGS. 2(a) and (b), it can be seen that screen 1100 identifies a reservation where there is a 6 day shortfall between the LAD and the amount of time needed by the repair facility to complete repairs. In the event that an extension authorization request is generated at step 216, the automated reservation management computer system preferably lists this request in an action items GUI screen 2200 as shown in FIG. 22 so that a reservation manager (a rental vehicle service provider employee in this example, although the reservation manager can also be an employee of the purchaser) can be informed of the need for the extension. Upon selection by the reservation manager of the “extension” action item from screen 2200, an extension authorization GUI screen 2300 such as the one shown in FIG. 23 is preferably displayed. Preferably, field 2302 of screen 2300 is automatically populated with the shortfall between the LAD and the computed time needed by the repair facility to complete repairs to the disabled vehicle (which in this example is 6 days). However, the reservation manager can optionally adjust this amount if desired. Furthermore, through field 2304, the reservation manager can define the rate to apply to the extension period. This field 2304 is preferably populated with the existing rate applicable to the reservation, however other rate values can be optionally selected. Thereafter, via selection of the “extend reservation” button 2306, the reservation manager can re-set the reservation's LAD in accordance with the extension amount in field 2302.

With respect to the manner by which the exemplary system 602 populates section 1204 of FIG. 12(b) with the appropriate DRS when the user updates a vehicle's repair status, it should be understood that DRSs can be associated with updates (e.g., repair status codes) and purchasers in any of a number of manners, as described in detail below.

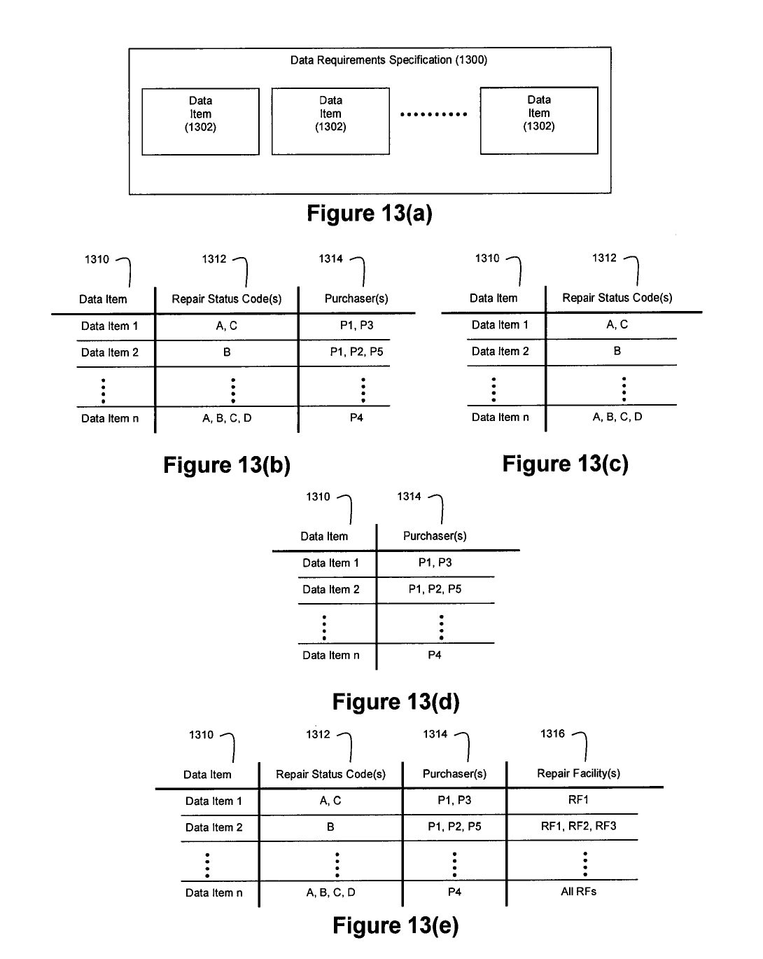

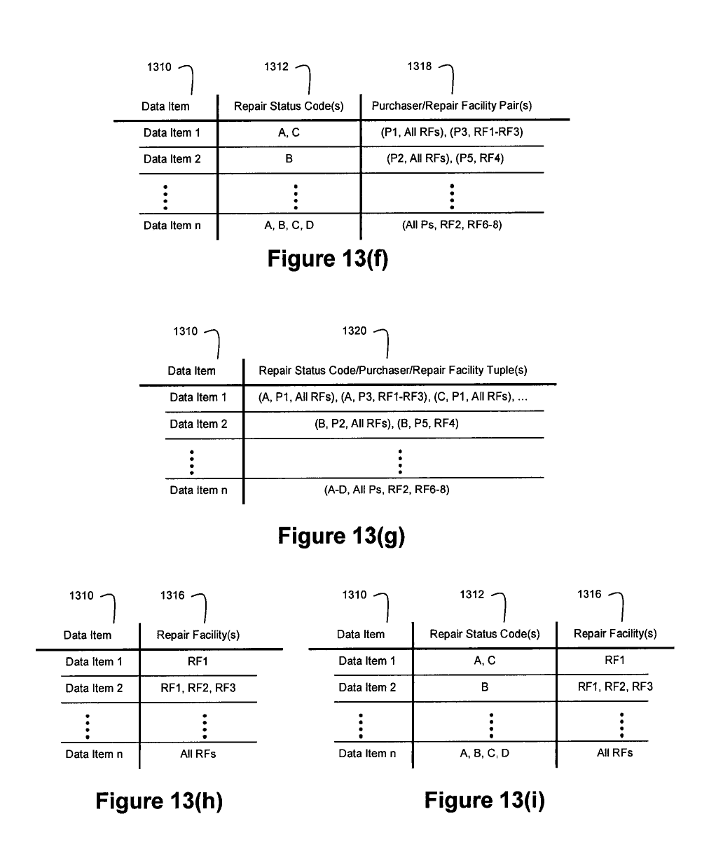

FIG. 13(a) shows an exemplary DRS 1300 that comprises a plurality of required data items 1302. Upon selection of a DRS, the system will preferably require information corresponding to each data item within that DRS, as described below and in connection with FIGS. 12(a) and (b). Preferably, the system 602 automatically communicates a request for the required data items to the repair facility computer system 606, and the repair facility computer system 606 preferably communicates answers to that request back to the system 602. Such automated communication can be achieved in a variety of ways, as will be understood by those of ordinary skill in the art. Optionally, the answers can be provided by a human, e.g. repair facility personnel who accesses GUI screen 1200 to provide input in fields 1206, 1208, 1210, and 1212. Preferably, the answers are further communicated to the relevant purchaser computer system 604 via system 602.

FIGS. 13(b)-(i) depict conceptual tables that illustrate various examples of how data items can be associated with various entities to form a DRS.

FIG. 13(b) depicts an exemplary arrangement wherein each required data item 1302 (shown in column 1310) is associated with at least one repair status code (column 1312) and at least one purchaser (column 1314). In this way, each purchaser may define its own DRS to be used for a given repair status code. Preferably, the plurality of repair status codes comprises a standard list of repair status codes, such as the standardized CIECA messages discussed above. However, this need not be the case.

FIG. 13(c) depicts an exemplary arrangement wherein each required data item 1302 is associated with at least one repair status code. In an arrangement such as that of FIG. 13(c), each purchaser would share the same DRS for a given repair status code.

FIG. 13(d) depicts an exemplary arrangement wherein each required data item 1302 is associated with at least one purchaser. In an arrangement such as that of FIG. 13(d), the DRS would not change based on which repair status code was selected, although DRSs may vary by purchaser.

FIG. 13(e) depicts an exemplary arrangement wherein each required data item 1302 is associated with at least one repair status code, at least one purchaser, and at least one repair facility (column 1316). In an arrangement such as that of FIG. 13(d), the DRS would not change based not only on which repair status code was selected, but also by which purchaser and which repair facility is applicable to that repair work. With respect to the table of FIG. 13(e), it should be noted that additional dependencies may be needed to tie the proper repair facilities with the proper purchasers when assembling DRSs, in accordance with conventional database practices. An example of such a table is shown in FIG. 13(f), wherein data items are associated with purchaser/repair facility pairs (column 1318). In this manner, the system can easily accommodate situations where multiple purchasers share the same data item with respect to a status code, but not all of those purchasers wish to further associate that data item with the same repair facilities. It should be noted that a similar concept of constraint pairs can be used with respect to the exemplary embodiment of FIGS. 13(b) and 13(i) (e.g., repair status code/purchaser pairs or repair status code/repair facility pairs). Further still, data items can also be associated with repair status code/purchaser/repair facility tuples, as shown in column 1320 of FIG. 13(g).

FIG. 13(h) depicts an exemplary arrangement wherein each required data item 1302 is associated with at least one at least one repair facility. In an arrangement such as that of FIG. 13(h), the DRS would vary by repair facility. As such, multiple purchasers would be sharing the same DRSs with respect to the same repair facility.

FIG. 13(i) depicts an exemplary arrangement wherein each required data item 1302 is associated with at least one repair status code and at least one at least one repair facility.

It should also be understood that other associations can be made to data items 1302 for the purpose of assembling a DRS. For example, data items 1302 can be associated with various conditions as noted above which define how a DRS display will be triggered, as mentioned above.

Also, relational databases can be used to store data corresponding to the data items and their associations with other entities. In such a database, each data item can be represented by a text question/request that is formulated to prompt a response from the user that would serve as the pertinent required data item 1302. In this way, upon receipt of a repair status code from a repair facility, the system can query the database using constraints such as the applicable repair status code, the applicable purchaser, the applicable repair facility, the applicable condition, etc. to retrieve all data items 1302 that belong in a particular DRS.

It should be understood that the use of wildcard operators in the tables of FIGS. 13(b)-(i) can be used to identify that a particular constraint field will not serve as a constraint with respect to a particular data item. For example, with respect to FIG. 13(e), it can be seen that the repair facility constraint will not be relevant to the selection of Data Item n when the received repair status code is either A, B, C, or D and the purchaser is P4. Similarly, with respect to FIG. 13(f), it can be seen that all purchasers will share Data Item n when the received repair status code is A, B, C, or D and the repair facility is RF2 or any of RFs 6-8. In this way, particular data items can said to be “global” with respect to a particular constraint. It should also be understood that range operators can be used to specify associations where multiple constraints of the same type are to be associated with a data item (see, e.g., FIGS. 13(f) and (g)).

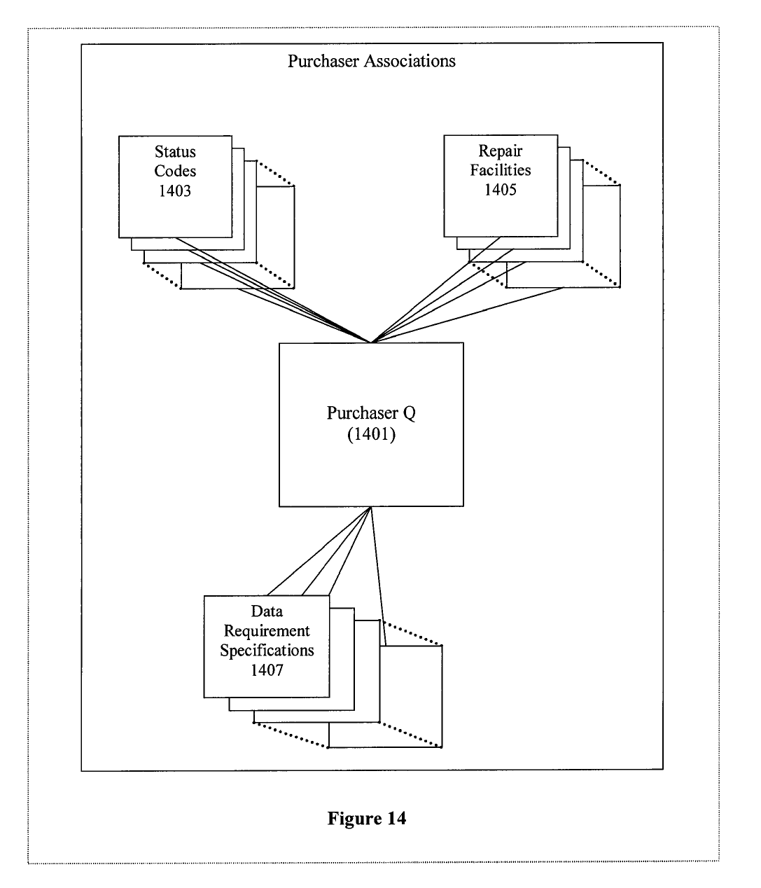

It should also be noted that the database need not granularize DRSs at the constituent data item level. If desired, the database can be configured to make associations at the DRS level. Each DRS would effectively correspond to a data object or file that includes all of its constituent required data items. In such instances, the conceptual tables shown in FIGS. 13(b)-(i) would associate entire DRSs to various constraints. While this may involve some redundant storage of the same data items that are shared by multiple DRSs, it may also provide some benefits relating to ease of DRS-level management. An example of such a conceptual arrangement is shown in FIG. 14, wherein multiple DRSs 1407 are associated with a purchaser 1401, multiple repair status codes 1403, and multiple repair facilities 1405.

Preferably, the system 602 provides each purchaser with an ability to control and modify the associations between its data items/DRSs and their associated constraints. For example, a GUI interface between purchaser computer system 604 and system 602 through data path 616 can be used for that purpose.

With respect to embodiments wherein the data item/DRS associations can vary by purchaser and repair facility, such as shown in FIGS. 13(e), (f), and (g), this allows the system 602 to accommodate situations where a purchaser has business relationships with different “levels” of repair facilities. A purchaser may or may not have an established business relationship with a given associated repair facility. As such, it should also be understood that a purchaser may have varying levels of trust for different repair facilities. For example, suppose that repair facility A has a well-established business relationship with purchaser Q, while repair facility B has a lesser relationship (or no such relationship). In this example, purchaser Q might wish to require more information from repair facility B than it would require from repair facility A. This can be accomplished, in an exemplary embodiment, by associating one DRS with repair facility A and another DRS with repair facility B. In this example, the DRS associated with trusted repair facility A would likely require less detailed information in a given situation than the DRS associated with less-trusted repair facility B. FIG. 15 depicts an example of such an embodiment.

FIG. 15 depicts an exemplary DRS 1502 associated with a trusted repair facility A, and an exemplary DRS 1520 associated with a less-trusted repair facility B. Such a DRS can be selected at least partially in response to receiving a repair status code corresponding to a “Waiting on Parts” status. As can be seen in FIG. 15, DRS 1502 contains 4 data items: data item 1504 which corresponds to the name of the part causing the wait, data item 1506 which corresponds to the name of the parts supplier for that part, data item 1508 which corresponds to the date on which the repair facility ordered that part, and data item 1510 which corresponds to the expected arrival date for that part. However, the DRS 1520 associated with the less trusted repair facility includes additional data items 1512 and 1514, which correspond respectively to the order number for the order placed with the part supplier and the shipping method selected for the order.

In an exemplary embodiment, a single DRS such as DRS 1502 could be associated with a plurality of trusted repair facilities. In an exemplary embodiment, a single DRS such as DRS 1520 could be associated with a plurality of less-trusted repair facilities. In another exemplary embodiment, a DRS such as DRS 1502 might be associated with a “high” trust level, and a plurality of repair facilities might be associated with an identifier for a “high” trust level. In yet another exemplary embodiment, a DRS such as DRS 1520 might be associated with a “low” trust level, and a plurality of repair facilities might be associated with an identifier for a “low” trust level. It should also be understood that a wider range of “trust” levels can be used with respect to repair facilities, such as a “high”, “medium”, “low” framework or an even more granular framework.

In some cases there may be no associations stored for a particular repair facility with respect to a particular purchaser. In such a scenario, a purchaser can designate a particular data item or DRS (or plurality of data items/DRSs) as “default”. Such a default data item/DRS would apply to any repair facility for which the system does not have any stored associations for that purchaser (e.g. newly added repair facilities, or repair facilities which the purchaser has not previously done business with).

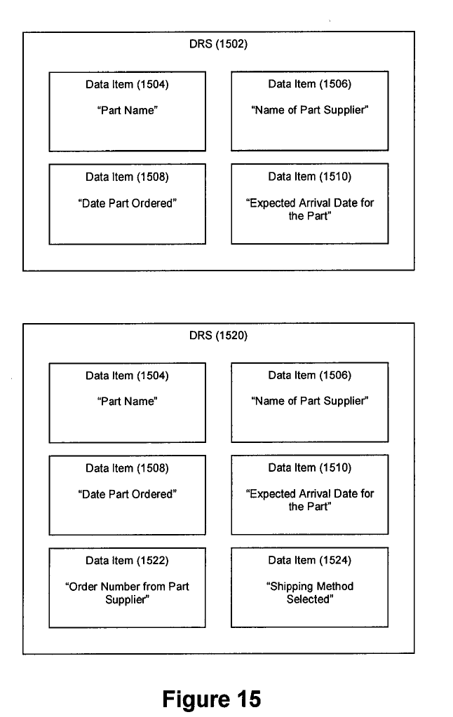

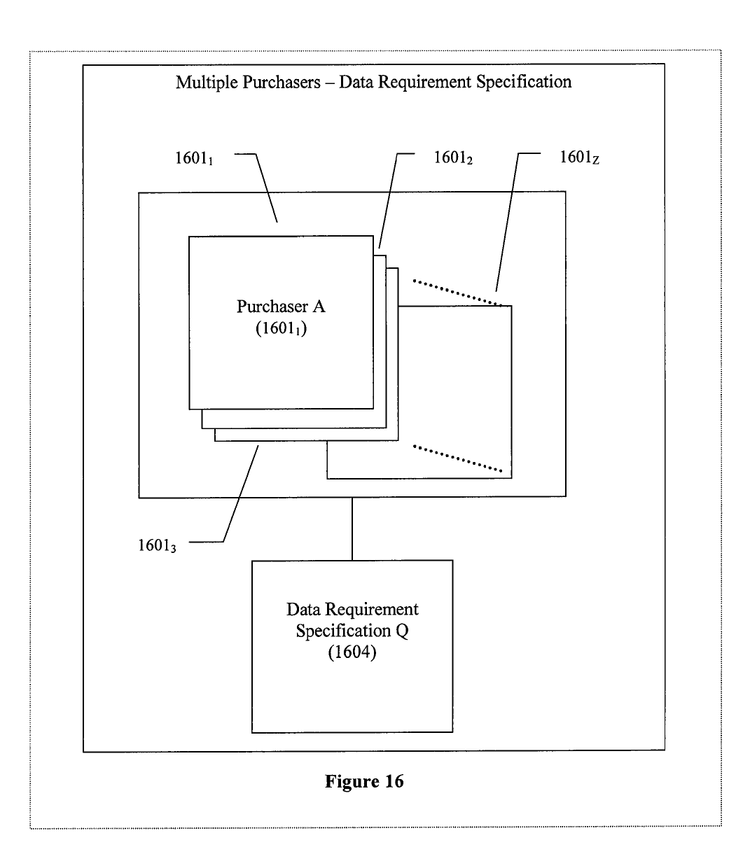

FIG. 16 depicts an exemplary DRS Q 1604 that is associated with an exemplary plurality of purchasers 1601. The exemplary plurality of purchasers 1601 depicted in FIG. 16 comprises a first purchaser A 1601₁, a second purchaser 1601₂, a third purchaser 1601₃, and a Z^{th} purchaser 1601_{z}. This shows that each DRS need not necessarily be limited to use by a single purchaser. A single DRS may be utilized by multiple purchasers. One example of such use could be referred to as a “Template DRS.” In an exemplary embodiment, multiple purchasers can be associated with a template DRS. In this exemplary embodiment, purchasers with no special data requirements could conveniently choose to use a template DRS provided by the system. In another exemplary embodiment, multiple template DRSs could be provided, for example: one template DRS could be provided for each of a: “high”, “medium” and “low” trust level, thereby allowing a purchaser to conveniently associate a DRS with a given repair facility (or multiple repair facilities) without having to create a new DRS from scratch. In another exemplary embodiment, the system could provide a user with the ability to start with a template DRS and modify various aspects of the template DRS, and save the new (modified) DRS, thereby allowing a user to conveniently define customized DRSs without having to create a new DRS from scratch. For example, a user could start with a template DRS, modify the data items required for various status updates, and then save the modified DRS. The user in this example could then associate the saved modified DRS with one or more other constraints.

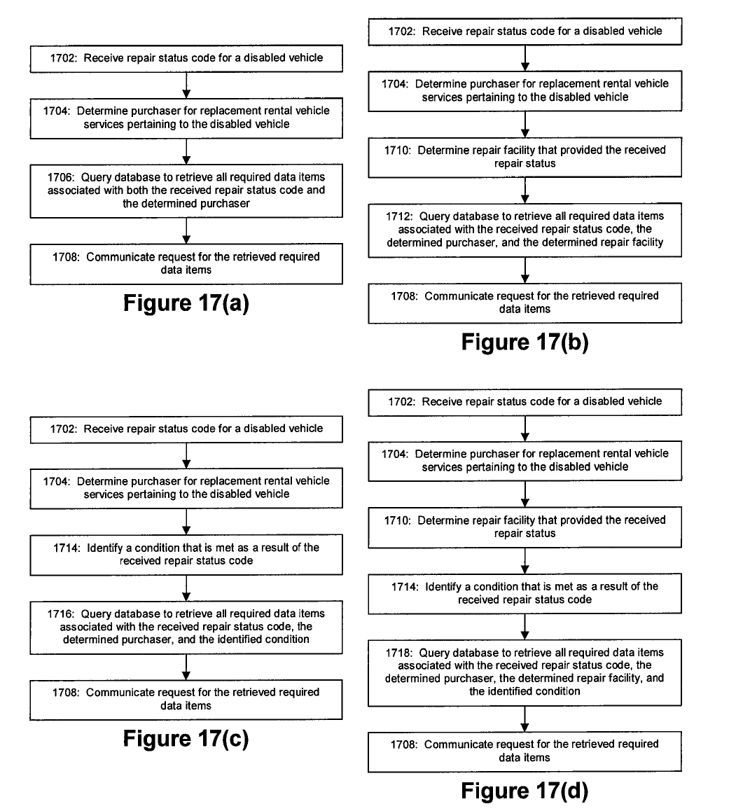

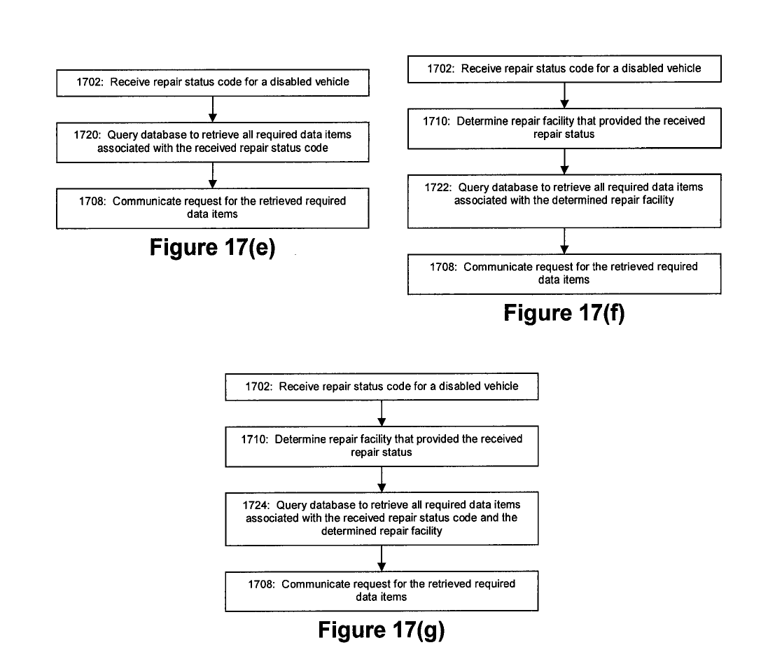

FIGS. 17(a)-(g) depict an overview of a DRS selection process in various exemplary embodiments. These process flows are preferably performed by system 602.

FIG. 17(a) depicts a process flow for an embodiment wherein DRS selection is based on purchaser identity. At step 1702, the system receives an update pertaining to a disabled vehicle. This update preferably includes a repair status code. Preferably, this repair status code is received directly from a repair facility via the Internet, although this need not be the case. The repair facility can provide this update to the system 602 in any of a number of ways. In accordance with a first exemplary embodiment, a user of a repair facility computer 606 accesses system 602 over a network such as the Internet and a GUI screen such as GUI screen 1200 is displayed on the repair facility computer for user submission of the update. In accordance with another exemplary embodiment, the repair facility computer 606 communicates the update to the system 602 via a web service communication (see FIG. 10). In accordance with yet another exemplary embodiment, the repair facility computer 606 has a data pump installed thereon to automatically “pump” new vehicle repair data to the system 602 (optionally by way of data server 720 shown in FIG. 7), as disclosed in the above-referenced and incorporated published patent application 2008/0162199. The update information can be included in this vehicle repair data. In this way, repair facility personnel need not access both their own software systems and an interface to system 602 to provide system 602 with vehicle repair data.

At step 1704, the system identifies a purchaser Q associated with the received repair status code. This purchaser will be the purchaser for the replacement rental vehicle services corresponding to the disabled vehicle upon which repairs are being performed. Data within the received update will be sufficient to allow the system 602 to tie that update to a particular purchaser. For example, a database within system 602 preferably associates purchasers to identifiers such as an identifier for a particular repair job or an identifier a particular claim number. By including such identifiers in the update, the system 602 can query the database to determine which purchaser is tied to a particular update.

At step 1706, the system selects a DRS by querying the database to retrieve all required data items that are associated with the received repair status code and the determined purchaser. As noted above, this retrieval can be performed at a data item level or at a DRS level, depending upon whether the database organizes the associations at a DRS level or a data item level.

Next, at step 1708, the system communicates a request for the retrieved required data items to a computer, preferably to repair facility computer 606. As noted above, in one embodiment, this request can take the form of questions presented on a GUI screen such as those in section 1204 of GUI screen 1200 shown in FIG. 12(b). In another exemplary embodiment, the system communicates this request to the repair facility computer 606 as a web service request. In this way, a repair facility can respond to the request using its existing software and without the need to access a GUI screen provided by system 602. Preferably, the repair facility's response to the request is communicated to system 602 as a web service response. In yet another exemplary embodiment, the repair facility computer system 606 includes a data pump which is configured to automatically communicate its vehicle repair data to data server 720. In such an instance, one or more of the required data items may be resident on server 720. Thus, the system 602 can be configured to submit its request (at least in part) to server 720, and server 720 can be configured to search for responses to the request from within its stored vehicle repair data. For any vehicle repair data that is not resident on server 720, the system 602 (and/or server 720) can be configured to communicate the request (or a portion thereof) to the repair facility computer system. To obtain responses to such a request, intervention by repair facility personnel may be necessary.

FIG. 17(b) depicts an exemplary process flow where DRS selection is also contingent on which repair facility submits the update at step 1702. Thus, at step 1710, the system determines which repair facility submitted the update at step 1702. This determination is preferably a straightforward determination based on the content of the received update. Then, at step 1712, the database querying/retrieval operation operates to also use the determined repair facility as a constraint when retrieving pertinent required data items.

FIG. 17(c) depicts an exemplary process flow where the DRS selection is contingent on a condition being met (as well as the received repair status code and the determined purchaser). Examples of such conditions are described above (e.g., a condition such as the update triggering a need for an extension, a condition such as the updated triggering an increase in estimated repair costs beyond a threshold, etc.). Thus, at step 1714, the system identifies a condition that is met. It should be understood that the condition and its identification can be based on any of a number of factors including any vehicle repair data found in the received update. Then at step 1716, the database querying/retrieval operation operates to also use the identified condition as a constraint when retrieving pertinent required data items.

FIG. 17(d) depicts an exemplary process flow where the DRS selection is contingent on a condition being met (as well as the received repair status code, the determined purchaser, and the determined purchaser).

FIG. 17(e) depicts an exemplary process flow where the DRS selection is contingent on the received repair status code, but not a determined purchaser, a determined repair facility, or an identified condition. Thus, the database querying/retrieval step 1720 need only use the received repair status code as a constraint.

FIG. 17(f) depicts an exemplary process flow where the DRS selection is contingent upon the repair facility which provided the received repair status code. Thus, the database querying/retrieval step 1722 need only use the determined repair facility as a constraint.

FIG. 17(g) depicts an exemplary process flow where the DRS selection is contingent upon both the received repair status code and the repair facility which provided that received repair status code. Thus, the database querying/retrieval step 1724 need only use the received repair status code and the determined repair facility as constraints.

It should be noted that, with any of the process flows of FIGS. 17(a)-(g), the performance of step 1708 can be predicated on a particular condition being met, as explained above (e.g., the received update triggering a need for an extension of the authorization period for the relevant replacement rental vehicle reservation). Furthermore, it should be understood that alternative processes can be used to select an appropriate DRS. For example, the retrieval of required data items to be included in a DRS can be based entirely on the purchaser determined at step 1704, in which case the same DRS would be used for a given purchaser with respect to all types of received updates.

When the required data items are received by the system from the repair facility computer system, these received data items can be stored in a database for subsequent retrieval. Furthermore, it should be noted that these data items may be used to populate a notes section of a reservation management GUI screen, such as a section 2102 in FIG. 21. In this way, a reservation manager can quickly ascertain the required data items provided by the repair facility. Similarly, an action item can also be created for inclusion on the action item list of a GUI screen such as the one shown in FIG. 22 when a repair facility communicates the required data items to the system. Furthermore, should the repair status update have triggered a need for a reservation extension, the required data items provided by the repair facility can also be communicated to a reservation manager through a GUI screen such as that shown by FIG. 23. In this way, the reservation manager can review the required data items provided by the repair facility when deciding whether to authorize an extension.

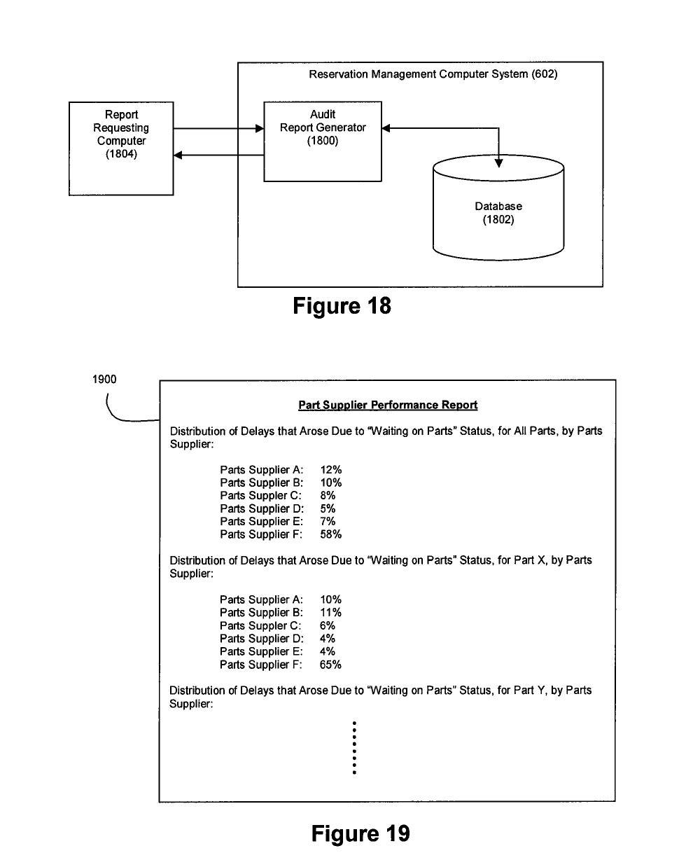

By collecting answers to the requests communicated at step 1708, the system 602 can also be used as a valuable information resource with respect to auditing various business practices within the replacement rental market. System 602 preferably stores the answers to the requests in a database 1802, as shown in FIG. 18. Furthermore, an audit report generator 1800 is preferably executed by system 602 to access the information stored in database 1802 to generate and provide an audit report to a report requesting computer 1804 (preferably over a network as shown in FIGS. 6 and 7). Computer 1804 can be a purchaser computer 606, a repair facility computer 606, or even another computer within a rental vehicle service provider's computer network. These audit reports can describe relative performances of various vendors in the supply chain for repair work. For example, FIG. 19 illustrates an exemplary audit report 1900 produced in accordance with the embodiment of FIG. 18, wherein the relative performance of various parts suppliers is described. The data needed to support such a report can readily be culled from the answers that repair facilities provide to requests sent at step 1708 after the repair facility provides a status updated corresponding to a “Waiting on Parts”. In this example, the audit report can identify which parts suppliers are more problematic than others with respect to providing repair facilities with parts (optionally, by particular parts or across all parts). From this information, a purchaser or reservation manager can decide upon and suggest best practices policies for repair facilities with respect to ordering replacement parts to reduce instances where extra costs are incurred due to delays in parts procurement. However, it should be understood that a vast wealth of different types of audit reports can be generated from the data within database 1802.

Additional details about audit report generation in connection with system 602 can be found in the above-referenced and incorporated U.S. Patent Application Publication 2008/0140460.

While the present invention has been described above in relation to its preferred embodiment, such description is intended to be merely illustrative of the invention and various modifications may be made thereto that still fall within the invention's scope, as would be recognized by those of ordinary skill in the art upon review of the teachings herein.

For example, it should be noted that a practitioner of the invention can optionally choose to configure the rental calculator software 610 to automatically adjust a reservation's LAD to match the TCD computed therefor at step 208 of FIG. 2 even if a reservation's previous LAD falls after the newly-computed TCD.

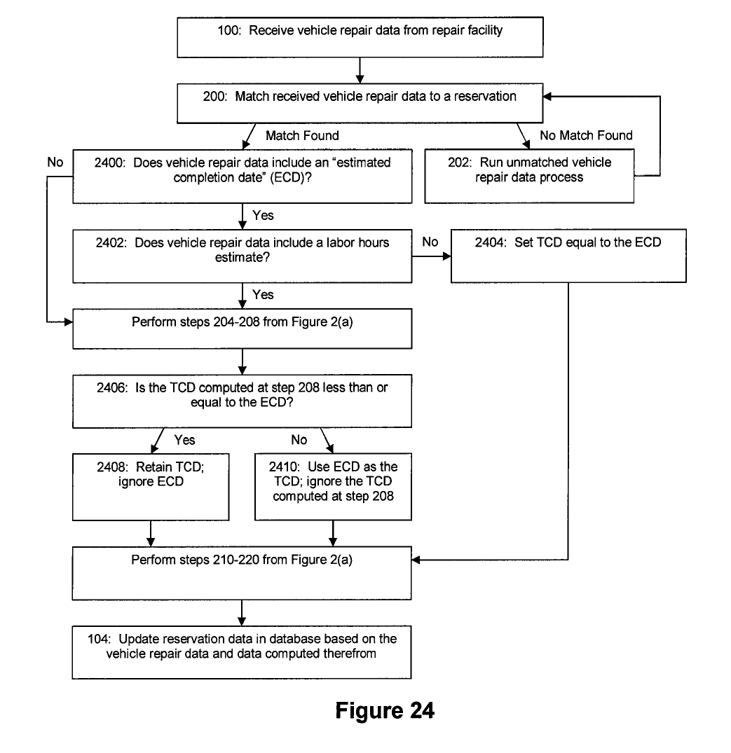

Furthermore, for repair facilities that may provide the automated reservation management computer system 602 with an “estimated completion date” (ECD) in addition to other vehicle repair data such as labor hours, etc., a process flow such as the one shown in FIG. 24 can be employed. The ECD represents an estimate by the repair facility as to how long the repair facility needs to complete repairs to the subject disabled vehicle. Repair facilities may provide this ECD information independently of and in addition to labor hours estimates. In such a case, the process flow of FIG. 24 operates to decide whether the ECD or the TCD (computed from the labor hours data via formulas (1) and (2)) should be used to control the extension decision making process. Each purchaser can define the situations in which the ECD will control and the situations in which the labor hours-derived TCD will control. In the example of FIG. 24, the controlling value will be the smaller of the ECD and TCD values. However, it should be noted that a purchaser or other party may choose to use the larger of the two values to control the extension process. Further still, rather than comparing the ECD and the TCD to determine which is smaller or larger, it should be noted that the comparison can be made to determine which was most recently updated (e.g., where an initial repair estimate provides labor hours from which the TCD is computed, but a few days later the repair facility provides an updated repair estimate for that disabled vehicle with the same labor hours but now including an ECD, or where an initial repair estimate provides an ECD but no labor hours and a subsequent repair estimate for the same disabled vehicle includes labor hours). In such an embodiment, the flow of FIG. 24 can be modified to use the most recently updated value as between TCD and ECD as the controlling value. The flow of FIG. 24 modifies the flow of FIG. 2(a) as follows. Steps 2400 and 2402 are introduced to determine whether either or both of an ECD value and a labor hours value are included in the vehicle repair data for the reservation (in this example, it will be assumed that at least one of these values is present in the vehicle repair data applicable to the reservation). If no labor hours are present, then at step 2404, the TCD is set equal to the ECD value, and the process jumps to step 210 of FIG. 2(a). If both an ECD and an estimate of labor hours are present in the vehicle repair data, then the process computes the TCD value from the labor hours as previously described in connection with steps 204-208 of FIG. 2(a). Thereafter, at step 2406, the computed TCD value is compared with the ECD value to determine which is smaller. If the TCD value is less than or equal to the ECD value, then the process flow of steps 210-220 of FIG. 2(a) are driven by the TCD value (step 2408). If the ECD value is less than the TCD value, then the process flow of steps 210-220 of FIG. 2(a) are driven by the ECD value (step 2410). In this manner, the rental calculator 610 can accommodate repair facilities which may provide ECD data in addition to or instead of labor hours data. It should also be noted that the process flow of FIG. 24 can also be incorporated into the process flow of FIG. 2(b).

Further still, when the vehicle repair data includes both an ECD and labor hours, a practitioner of the invention can also choose to follow the flow of FIG. 2(a) or 2(b), in which case the ECD value will be effectively ignored.

Still further, the formula used to compute f(r) can alternately be expressed as

$$f ( r ) = \frac{LC}{LCS ( i )} + ND ( i ) + A ( i , r ) \qquad ( 2 a )$$

wherein LC represents the labor costs estimated by the repair facility to repair the disabled vehicle (as defined in the received vehicle repair data), and wherein LCS(i) represents a labor costs scalar defined for the purchaser i. The value of the labor costs scalar is preferably selected to scale the labor costs to a number of days (e.g., number of business days) that will be needed to perform the repairs corresponding to the estimated labor costs on the disabled vehicle. As noted for LHS above, the value of LCS can be defined on a purchaser-by-purchaser basis, on a repair facility-by-repair facility basis or some combination of a purchaser and repair facility basis.

Moreover, as described in the above-referenced and incorporated U.S. Patent Application Publication 2008/0140460, authorized personnel can also be given the ability to define the rules used by the rental calculator 610, automated callback scheduler 612, and/or audit report generator 614 through one or more GUI screens. Preferably, appropriately authorized employees of the purchaser are given access to these GUI screens through data path 616. Similarly, for any such GUI screens to which repair facility personnel are allowed access, such access is preferably provided via data path 618 (or paths 722 and/or 724).

Also, it will be apparent to those of ordinary skill in the art that embodiments of the present invention as described herein can be achieved using a variety of systems and techniques.

The computer instructions for performing the processes described herein can comprise either client-side or server-side programming, or any combination of the two. Moreover, the present invention is not limited to a client-server architecture. One of ordinary skill in the art would appreciate that other implementations are possible within the scope of the present invention.

Preferably, the system is accessible via the internet so that the system can be used by any authorized person with an internet connection. Preferably, each purchaser would be given limited access only to its own profile. Purchasers would typically designate one or more employees of the purchaser as authorized representatives for the purchaser. These authorized users would be allowed to modify the associations for only that purchaser. Preferably, each repair facility would be given limited access to enter approval requests and status updates for disabled vehicles in the repair facility's custody. Preferably, each purchaser would be given limited access to accept or reject approval requests for renters associated with that purchaser.

It should also be understood that the follow-up features described herein for enhanced information sharing with repair facilities can be employed in a reservation management computer system 602 that does not employ a rental calculator feature and/or a callback scheduler feature.

Furthermore, it should be understood that repair facilities can optionally employ batch processing techniques when submitting updates to the system 602. In such an instance, a plurality of different updates may be received at step 1702.

As such, the full scope of the present invention is to be defined solely by the appended claims and their legal equivalents.

What is claimed is:

1. A computer-implemented method for managing a rental vehicle reservation for a replacement vehicle associated with a disabled vehicle, the method comprising:
receiving an update corresponding to a disabled vehicle;
determining a purchaser for a rental vehicle reservation associated with the disabled vehicle corresponding to the received update;
selecting at least one required data item based at least in part on the determined purchaser; and
communicating a request for the at least one required data item to a computer.

2. The method of claim 1 wherein the update comprises a repair status for the disabled vehicle.

3. The method of claim 2 wherein the computer comprises a repair facility computer, and wherein the required data item comprises an answer to a question directed to a repair facility for the disabled vehicle.

4. The method of claim 3 wherein the communicating step comprises providing a graphical user interface (GUI) screen for display on the computer, the GUI screen being configured to display the request and receive input from a user of the computer, the input corresponding to the at least one required data item.

5. The method of claim 4 wherein the receiving step comprises receiving the update through a GUI screen displayed on the repair facility computer, and wherein the GUI providing step comprises refreshing the already displayed GUI screen such that it displays the request and at least one field for user entry of input as a response to the request.

6. The method of claim 3 further comprising:
determining a repair facility associated with the disabled vehicle corresponding to the received repair status; and
wherein the selecting step comprises selecting at least one required data item based at least in part on the determined repair facility and the determined purchaser.

7. The method of claim 3 wherein the selecting step comprises selecting at least one required data item based at least in part on the received repair status and the determined purchaser.

8. The method of claim 3 further comprising determining a condition that is triggered by the received repair status, and wherein selecting step comprises selecting at least one required data item based at least in part on the determined condition.

9. The method of claim 8 wherein the condition comprises a need for an approval request.

10. The method of claim 9 wherein the approval request comprises a request for an extension of an authorization period for the rental vehicle reservation.

11. The method of claim 3 wherein the condition comprises a repair cost estimate that exceeds a reference.

12. The method of claim 3 wherein the selecting step comprises selecting a plurality of required data items based at least in part on the determined purchaser, and wherein the communicating step comprises communicating a request for the plurality of required data items to the computer.

13. The method of claim 12 further comprising:
receiving the required data items from the computer; and
communicating the required data items to a reservation manager.

14. The method of claim 13 further comprising:
determining a need for an approval request that is triggered by the received repair status; and
communicating the approval request to the reservation manager together with the communicated required data items.

15. The method of claim 3 further comprising:
associating a plurality of required data items with a plurality of different purchasers, wherein each required data item is associated with at least one purchaser.

16. The method of claim 15 further comprising:
associating at least a first plurality of the required data items with a plurality of different repair facilities, wherein each of the first plurality of the required data items is associated with at least one repair facility.

17. The method of claim 3 wherein the selecting step comprises selecting a plurality of required data items based at least in part on the determined purchaser, wherein the communicating step comprises communicating a request for the plurality of required data items to the computer, the method further comprising:
receiving the required data items from the computer;
performing the update receiving, determining, selecting, communicating, and required data item receiving steps for a plurality of different disabled vehicles and a plurality of different repair facilities;
storing the received required data items in a database; and
generating a report from the stored data items.

18. The method of claim 17 wherein at least a portion of the stored data items identify a parts supplier for at least one repair facility that is late with respect to providing the at least one repair facility with at least one part needed for repair work, and wherein the report indicates a relative performance of that parts supplier with respect to a plurality of other parts suppliers.

19. The method of claim 3 wherein the purchaser comprises an insurance company.

20. The method of claim 3 wherein the communicating step comprises communicating the request as a web service request.

21. The method of claim 20 further comprising receiving the at least one required data item as a web service response to the web service request.

22. The method of claim 2 wherein the selecting step comprises selecting a plurality of required data items based at least in part on the determined purchaser, wherein the communicating step comprises communicating a request for the plurality of required data items to the computer, wherein the computer comprises a server in communication with a repair facility computer, wherein each required data item comprises an answer to a question corresponding to the disabled vehicle, wherein the repair facility computer comprises a data pump that is configured to automatically communicate vehicle repair data about the disabled vehicle to the server, and wherein the communicating step comprises submitting at least a portion of the request to the server.

23. The method of claim 22 further comprising receiving at least one of the required data items from the server.

24. The method of claim 22 wherein the communicating step further comprises submitting a portion of the request to the server and another portion of the request to the repair facility computer.

25. The method of claim 24 further comprising receiving at least one of the required data items from the repair facility computer.

26. The method of claim 1 further comprising performing the receiving, determining, selecting, and communicating steps with a reservation management computer system.

27. A computer system for managing a rental vehicle reservation for a replacement vehicle associated with a disabled vehicle, the computer system being configured to:
receive an update corresponding to a disabled vehicle;
determine a purchaser for a rental vehicle reservation associated with the disabled vehicle corresponding to the received update;
select at least one required data item based at least in part on the determined purchaser; and
communicate a request for the at least one required data item to another computer.

28. The system of claim 27 wherein the update comprises a repair status for the disabled vehicle.

29. The system of claim 28 wherein the another computer comprises a repair facility computer, and wherein the required data item comprises an answer to a question directed to a repair facility for the disabled vehicle.

30. The system of claim 29 wherein the computer system is further configured to perform the request communication by providing a graphical user interface (GUI) screen for display on the another computer, the GUI screen being configured to display the request and receive input from a user of the another computer, the input corresponding to the at least one required data item.

31. The system of claim 30 wherein the computer system is further configured to:
receive the update through a GUI screen displayed on the repair facility computer; and
perform the request communication by refreshing the already displayed GUI screen such that it displays the request and at least one field for user entry of input as a response to the request.

32. The system of claim 29 wherein the computer system is further configured to:
determine a repair facility associated with the disabled vehicle corresponding to the received repair status; and
select the at least one required data item based at least in part on the determined repair facility and the determined purchaser.

33. The system of claim 29 wherein the computer system is further configured to select the at least one required data item based at least in part on the received repair status and the determined purchaser.

34. The system of claim 29 wherein the computer system is further configured to:
determine a condition that is triggered by the received repair status;
select at least one required data item based at least in part on the determined condition.

35. The system of claim 34 wherein the condition comprises a need for an approval request.

36. The system of claim 35 wherein the approval request comprises a request for an extension of an authorization period for the rental vehicle reservation.

37. The system of claim 29 wherein the condition comprises a repair cost estimate that exceeds a reference.

38. The system of claim 29 wherein the computer system is further configured to:
select a plurality of required data items based at least in part on the determined purchaser;
communicating a request for the plurality of required data items to the another computer.

39. The system of claim 38 wherein the computer system is further configured to:
receive the required data items from the another computer; and
communicate the required data items to a reservation manager.

40. The system of claim 39 wherein the computer system is further configured to:
determine a need for an approval request that is triggered by the received repair status; and
communicate the approval request to the reservation manager together with the communicated required data items.

41. The system of claim 29 wherein the computer system is further configured to associate a plurality of required data items with a plurality of different purchasers, wherein each required data item is associated with at least one purchaser.

42. The system of claim 41 wherein the computer system is further configured to associate at least a first plurality of the required data items with a plurality of different repair facilities, wherein each of the first plurality of the required data items is associated with at least one repair facility.

43. The system of claim 29 wherein the computer system is further configured to:
select a plurality of required data items based at least in part on the determined purchaser;
communicate a request for the plurality of required data items to the another computer;
receive the required data items from the another computer;
perform the update receiving, determining, selecting, communicating, and required data item receiving operations for a plurality of different disabled vehicles and a plurality of different repair facilities;
store the received required data items in a database; and
generate a report from the stored data items.

44. The system of claim 43 wherein at least a portion of the stored data items identify a parts supplier for at least one repair facility that is late with respect to providing the at least one repair facility with at least one part needed for repair work, and wherein the report indicates a relative performance of that parts supplier with respect to a plurality of other parts suppliers.

45. The system of claim 29 wherein the computer system is further configured to communicate the request as a web service request.

46. The system of claim 45 wherein the computer system is further configured to receive the at least one required data item as a web service response to the web service request.

47. The system of claim 28 wherein the computer system is further configured to:
select a plurality of required data items based at least in part on the determined purchaser;
communicate a request for the plurality of required data items to the another computer, wherein the another computer comprises a server in communication with a repair facility computer, wherein each required data item comprises an answer to a question corresponding to the disabled vehicle, wherein the repair facility computer comprises a data pump that is configured to automatically communicate vehicle repair data about the disabled vehicle to the server; and
submit at least a portion of the request to the server.

48. The system of claim 47 wherein the computer system is further configured to receive at least one of the required data items from the server.

49. The system of claim 47 wherein the computer system is further configured to submit a portion of the request to the server and another portion of the request to the repair facility computer.

50. The system of claim 49 wherein the computer system is further configured to receive at least one of the required data items from the repair facility computer.

51. The system of claim 27 wherein the computer system comprises a reservation management computer system.

52. A computer-readable medium for managing a rental vehicle reservation for a replacement vehicle associated with a disabled vehicle, the computer-readable medium comprising:
a code segment executable by a processor, the code segment configured to (1) receive an update corresponding to a disabled vehicle, (2) determine a purchaser for a rental vehicle reservation associated with the disabled vehicle corresponding to the received update, (3) select at least one required data item based at least in part on the determined purchaser, and (4) communicate a request for the at least one required data item to a computer, wherein the code segment is resident on the computer-readable medium.

53. The computer-readable medium of claim 52 wherein the update comprises a repair status for the disabled vehicle.

54. The computer-readable medium of claim 53 wherein the computer comprises a repair facility computer, and wherein the required data item comprises an answer to a question directed to a repair facility for the disabled vehicle.

55. The computer-readable medium of claim 54 wherein the code segment is further configured to provide a graphical user interface (GUI) screen for display on the computer, the GUI screen being configured to display the request and receive input from a user of the computer, the input corresponding to the at least one required data item.

56. The computer-readable medium of claim 55 wherein the code segment is further configured to (1) receive the update through a GUI screen displayed on the repair facility computer, and (2) refresh the already displayed GUI screen such that it displays the request and at least one field for user entry of input as a response to the request.

57. The computer-readable medium of claim 54 wherein the code segment is further configured to (1) determine a repair facility associated with the disabled vehicle corresponding to the received repair status, and (2) select the at least one required data item based at least in part on the determined repair facility and the determined purchaser.

58. The computer-readable medium of claim 54 wherein the code segment is further configured to select the at least one required data item based at least in part on the received repair status and the determined purchaser.

59. A computer-implemented method for managing a rental vehicle reservation for a replacement vehicle associated with a disabled vehicle, the method comprising:
receiving an update corresponding to a disabled vehicle;
selecting at least one required data item based at least in part on the received update; and
communicating a request for the at least one required data item to a computer.

60. The method of claim 59 wherein the update comprises a repair status for the disabled vehicle.

61. The method of claim 60 wherein the computer comprises a repair facility computer, and wherein the required data item comprises an answer to a question directed to a repair facility for the disabled vehicle.

62. The method of claim 61 wherein the communicating step comprises providing a graphical user interface (GUI) screen for display on the computer, the GUI screen being configured to display the request and receive input from a user of the computer, the input corresponding to the at least one required data item.

63. The method of claim 62 wherein the receiving step comprises receiving the update through a GUI screen displayed on the repair facility computer, and wherein the GUI providing step comprises refreshing the already displayed GUI screen such that it displays the request and at least one field for user entry of input as a response to the request.

64. The method of claim 61 further comprising:
determining a purchaser for a rental vehicle reservation associated with the disabled vehicle corresponding to the received repair status;
determining a repair facility associated with the disabled vehicle corresponding to the received repair status; and
wherein the selecting step comprises selecting at least one required data item based at least in part on the determined repair facility, the determined purchaser, and the received repair status.

65. A computer system for managing a rental vehicle reservation for a replacement vehicle associated with a disabled vehicle, the computer system configured to:
receive an update corresponding to a disabled vehicle;
select at least one required data item based at least in part on the received update; and
communicate a request for the at least one required data item to another computer.

66. The system of claim 65 wherein the update comprises a repair status for the disabled vehicle.

67. The system of claim 66 wherein the another computer comprises a repair facility computer, and wherein the required data item comprises an answer to a question directed to a repair facility for the disabled vehicle.

68. The system of claim 67 wherein the computer system is further configured to perform the request communication by providing a graphical user interface (GUI) screen for display on the another computer, the GUI screen being configured to display the request and receive input from a user of the another computer, the input corresponding to the at least one required data item.

69. The system of claim 68 wherein the computer system is further configured to:
receive the update through a GUI screen displayed on the repair facility computer, and
perform the request communication by refreshing the already displayed GUI screen such that it displays the request and at least one field for user entry of input as a response to the request.

70. The system of claim 67 wherein the computer system is further configured to:
determine a purchaser for a rental vehicle reservation associated with the disabled vehicle corresponding to the received repair status;
determine a repair facility associated with the disabled vehicle corresponding to the received repair status; and
select the at least one required data item based at least in part on the determined repair facility, the determined purchaser, and the received repair status.

71. A computer-implemented method comprising:
providing a first graphical user interface (GUI) screen for display on a repair facility computer, the first GUI screen being configured to request user input corresponding to a repair status update, the repair status update pertaining to repair work for a disabled vehicle, the disabled vehicle being associated with a replacement rental vehicle reservation;
receiving the repair status update in response to user input through the first GUI screen;
selecting at least one follow-up question about the repair work based at least in part on the received repair status update;
providing a second GUI screen for display on the repair facility computer, the second GUI screen being configured to display each selected follow-up question and request user input corresponding to an answer to each selected follow-up question.

72. The method of claim 71 further comprising:
storing a plurality of follow-up questions, at least a plurality of the follow-up questions being associated with a purchaser of replacement rental vehicle services; and
determining a purchaser for the replacement rental vehicle reservation associated with the disabled vehicle; and
wherein the selecting step comprises selecting the at least one follow-up question about the repair work based at least in part on the received repair status update and the determined purchaser.

73. The method of claim 72 wherein the second GUI screen providing step comprises refreshing the first GUI screen in response to the receiving and selecting step such that the refreshed first GUI screen comprises the second GUI screen.

74. The method of claim 72 further comprising:
automatically computing a target completion date for the repair work to the disabled vehicle based at least in part on the received repair status update;
comparing the computed target completion date with a previous target completion date for the repair work to the disabled vehicle; and
conditioning a performance of the second GUI screen providing step on the comparing step resulting in a determination that the computed target completion date falls after the previous target completion date.

75. A computer-implemented method comprising:
collecting vehicle repair data in a database, the vehicle repair data comprising a plurality of responses to inquiries about progress of repair work on a plurality of disabled vehicles;
querying the database to generate a report based on the collected vehicle repair data that includes a comparative analysis of the repair work.

76. The method of claim 75 wherein the vehicle repair data comprises a plurality of identifications of parts suppliers that are associated with repair work for which there was a delay in parts delivery to at least one repair facility, and wherein the generated report displays data indicative of how well a plurality of different parts suppliers perform with respect to timeliness of parts delivery to repair facilities.

77. The method of claim 75 further comprising:
receiving a repair status corresponding to a disabled vehicle;
determining a purchaser for a rental vehicle reservation associated with the disabled vehicle corresponding to the received repair status;
selecting at least one required data item based at least in part on the determined purchaser; and
communicating a request for the at least one required data item to a repair facility computer;
receive the required data items from the repair facility computer;
perform the repair status receiving, determining, selecting, communicating, and required data item receiving steps for a plurality of different disabled vehicles and a plurality of different repair facilities; and
wherein the collected vehicle repair data comprises the received repair statuses and the received required data items.

78. A computer-implemented method for managing a repair of a disabled vehicle, the method comprising:
receiving an update corresponding to a disabled vehicle;
determining a repair facility associated with the disabled vehicle corresponding to the received update;
selecting at least one required data item based at least in part on the received update and the determined repair facility; and
communicating a request for the at least one required data item to a computer.

79. The method of claim 78 wherein the update comprises a repair status for the disabled vehicle.

80. The method of claim 79 wherein the computer comprises a repair facility computer, and wherein the required data item comprises an answer to a question directed to a repair facility for the disabled vehicle.

81. A computer-implemented method for managing a rental vehicle reservation for a replacement vehicle corresponding to a disabled vehicle, the method comprising:
receiving vehicle repair data related to the disabled vehicle into a computer program, the received vehicle repair data including an estimate of labor costs for completing repairs to the disabled vehicle; and
automatically computing with the computer program a term-related parameter for the rental vehicle reservation based at least in part on the received labor costs estimate.

82. The method of claim 81 wherein the automatically computing step comprises:
applying a formula to the received vehicle repair data to thereby compute the term-related parameter, wherein the formula includes a labor costs scalar to the labor costs estimate to translate the labor costs estimate into a number of business days needed by the repair facility to complete the repairs to the disabled vehicle.

83. The method of claim 82 wherein a plurality of business rules define the labor hours scalar on a party-specific basis.
